(19) United States
(12) Patent Application Publication
(10) Pub. No.: US 2026/0094176 A1
(43) Pub. Date: Apr. 2, 2026

(54) Inference Toolset

(71) Applicant: Juniper Strategies Advising, Inc., Austin, TX (US)

(72) Inventors: Kevin Ilcisin, Oregon City, OR (US); Thomas S. Buzak, Seattle, WA (US); Karl Krumm, Austin, TX (US); Darcy Dement, Austin, TX (US)

(73) Assignee: Juniper Strategies Advising, Inc., Austin, TX (US)

(21) Appl. No.: 19/347,989

(22) Filed: Oct. 2, 2025

Related U.S. Application Data
(60) Provisional application No. 63/702,494, filed on Oct. 2, 2024.

(51) Int. Cl. G06Q 30/0202; G06Q 10/0637

(52) U.S. Cl. CPC G06Q 30/02024; G06Q 10/06375

(57) ABSTRACT

An inference tool set having instructions to: gather data relating to value characteristics regarding a venture and a market from one or more data sources regarding the venture and the market; generate a plan circumplex, via the assessment tool circuit, visually representing plan strength scores of the plurality of value characteristics, respectively, and calculate a plan index of the plan circumplex; generate an actual circumplex, via the value creating engine circuits, visually representing actual strength scores of the value characteristics and calculate an actual index of the actual circumplex; align the actual circumplex with the plan circumplex, via an alignment assessment tool circuit, to identify value characteristics having large disparity between plan strength scores and actual strength scores; and forecast financial performance of the venture, via a forecast tool circuit, based on the plan strength scores, the actual strength scores, the plan index, and the actual index.

### CONTINUATION STATEMENT

This application claims priority to Provisional Patent Application No. 63/702,494, filed Oct. 2, 2024, the entire contents of which are incorporated herein by reference for all purposes.

### TECHNICAL FIELD

The present application relates to an inference toolset.

### BACKGROUND

Decision domains may utilize automated data ingestion, filtering, reduction, and storage of multiple different information types. These features may be used to enhance the quality and reduce the time and cost of making decisions. The features may include the approach of developing and deploying machine learning (ML) or artificial intelligence (AI) models. While improvements may be made in terms of quality, time, and cost, such benefits may be offset by increasing computing costs of ingesting, filtering, reducing and storing the information in data centers. Such data centers may deployed in public or private clouds, or in on-premise proprietary compute and storage systems. This computing cost offset may become even larger when the initial information that is processed is needed to refine or update the decision in the future. These competing drivers of outcomes affect all decision domains but become particularly challenging in the domains of planning and strategic planning where there is a high degree of uncertainty associated with prediction, as opposed to more typical inference tasks that are limited to known data spaces.

There is a need for an inference toolset.

### SUMMARY

Aspects provide an article of manufacture comprising: an assessment tool circuit associated with a processor; a plurality of value creating engine circuits associated with the processor; an alignment assessment tool circuit associated with the processor; a forecast tool circuit associated with the processor; and a non-transitory machine-readable medium, the medium including instructions, the instructions, when loaded and executed by the processor, cause the processor to: gather data relating to a plurality of value characteristics regarding a venture and a market from one or more data sources regarding the venture and the market; generate a plan circumplex, via the assessment tool circuit, visually representing plan strength scores of the plurality of value characteristics, respectively, and calculate a plan index of the plan circumplex; generate an actual circumplex, via the plurality of value creating engine circuits, visually representing actual strength scores of the value characteristics and calculate an actual index of the actual circumplex; align the actual circumplex with the plan circumplex, via an alignment assessment tool circuit, to identify value characteristics having large disparity between plan strength scores and actual strength scores; and forecast financial performance of the venture, via a forecast tool circuit, based on the plan strength scores, the actual strength scores, the plan index, and the actual index.

An aspect as in the preceding paragraph provides an article of manufacture, wherein the assessment tool circuit is a strategic processes assessment tool circuit, and wherein the plan index and the actual index comprise a plan Strategic Process Quality Index (SPQI) and an actual Strategic Process Quality Index (SPQI), respectively.

An aspect as in one of the preceding two paragraphs provides an article of manufacture, wherein the assessment tool circuit is a culture assessment tool circuit, and wherein the plan index and the actual index comprise a plan Culture Quality Index (CQI) and an actual Culture Quality Index (CQI), respectively.

An aspect as in one of the preceding three paragraphs provides an article of manufacture, wherein the plurality of value characteristics comprise at least twelve value characteristics and the plurality of value creating engines comprise at least twelve value creating engines.

An aspect as in one of the preceding four paragraphs provides an article of manufacture, wherein the plurality of value characteristics comprise at least one of: purchasing, consideration, new solution, new offering development, marketing and selling, production, cost of capital, education, warranty, reliability, usability, and financing.

An aspect as in one of the preceding five paragraphs provides an article of manufacture, wherein the plurality of value characteristics comprise at least one of: strategic direction, goals and objectives, vision, coordination and integration, agreement, core values, capability development, team orientation, empowerment, creating change, customer focus, and organizational learning.

An aspect as in one of the preceding six paragraphs provides an article of manufacture, wherein calculate a plan index of the plan circumplex comprises averaging the plan strength scores, and wherein calculate an actual index of the actual circumplex comprises averaging the actual strength scores.

An aspect as in one of the preceding seven paragraphs provides an article of manufacture, wherein forecast financial performance of the venture comprises computing a metric selected from revenue, COGS, or operating expense of an income statement based on an alignment of the actual circumplex with the plan circumplex.

An aspect as in one of the preceding eight paragraphs provides an article of manufacture, wherein forecast financial performance of the venture comprises forecasting based on assumptions for the value creating engine circuits as a function of time.

According to an aspect, there is provided a method comprising: gathering data relating to a plurality of value characteristics regarding a venture and a market from one or more data sources regarding the venture and the market; generating a plan circumplex, via the assessment tool circuit, visually representing plan strength scores of the plurality of value characteristics, respectively, and calculate a plan index of the plan circumplex; generating an actual circumplex, via the plurality of value creating engine circuits, visually representing actual strength scores of the value characteristics and calculate an actual index of the actual circumplex; aligning the actual circumplex with the plan circumplex, via an alignment assessment tool circuit, to identify value characteristics having large disparity between plan strength scores and actual strength scores; and forecasting financial performance of the venture, via a forecast tool circuit, based on the plan strength scores, the actual strength scores, the plan index, and the actual index.

An aspect as in the preceding paragraph provides a method, wherein the assessment tool circuit is a strategic processes assessment tool circuit, and wherein the plan index and the actual index comprise a plan Strategic Process Quality Index (SPQI) and an actual Strategic Process Quality Index (SPQI), respectively.

An aspect as in one of the preceding two paragraphs provides a method, wherein the assessment tool circuit is a culture assessment tool circuit, and wherein the plan index and the actual index comprise a plan Culture Quality Index (CQI) and an actual Culture Quality Index (CQI), respectively.

An aspect as in one of the preceding three paragraphs provides a method, wherein the plurality of value characteristics comprise at least twelve value characteristics and the plurality of value creating engines comprise at least twelve value creating engines.

An aspect as in one of the preceding four paragraphs provides a method, wherein the plurality of value characteristics comprise at least one of: purchasing, consideration, new solution, new offering development, marketing and selling, production, cost of capital, education, warranty, reliability, usability, and financing.

An aspect as in one of the preceding five paragraphs provides a method, wherein the plurality of value characteristics comprise at least one of: strategic direction, goals and objectives, vision, coordination and integration, agreement, core values, capability development, team orientation, empowerment, creating change, customer focus, and organizational learning.

An aspect as in one of the preceding six paragraphs provides a method, wherein calculate a plan index of the plan circumplex comprises averaging the plan strength scores, and wherein calculate an actual index of the actual circumplex comprises averaging the actual strength scores.

An aspect as in one of the preceding seven paragraphs provides a method, wherein forecast financial performance of the venture comprises computing a metric selected from revenue, COGS, or operating expense of an income statement based on an alignment of the actual circumplex with the plan circumplex.

An aspect as in one of the preceding eight paragraphs provides a method, wherein forecast financial performance of the venture comprises forecasting based on assumptions for the value creating engine circuits as a function of time.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1A illustrates a block diagram of an implementation of an inference set.

FIG. 1B shows a flow chart for generating metrics and assessments by the inference set implementation of FIG. 1A.

FIG. 2 illustrates one instance of a canonical set of data reduction filters to be used by strategic process assessment engine, which may utilize twelve specific data reduction classes and filters (engines).

FIG. 3 illustrates example results from strategic process assessment engine to determine a Strategic Processes Quality Index (SPQI).

FIG. 4 illustrates example results from strategic process assessment engine overlaid onto goals or planned results.

FIG. 5 illustrates one instance of a canonical set of data reduction filters to be used by culture assessment engine, which may utilize twelve specific data reduction classes and filters (engines).

FIG. 6 illustrates results from alignment assessment tool circuit based on the action outputs of strategic process assessment engine circuit and trait outputs of the culture assessment engine circuit.

FIG. 7 illustrates results from forecast tool circuit based on the outputs of alignment assessment tool circuit.

FIG. 8 illustrates a table, showing the relationships of the specific SPEx and the CQI and how they are used to estimate a multi-year Income Statement.

FIG. 9 illustrates a process for calculation of the SPEx(t) and income statement.

FIG. 10 illustrates additional results from forecast tool based on the outputs of alignment assessment tool, by watching just a handful of gap values (the ten numbers inside the delta, or triangle, shapes) progress of strategic processes and culture may be tracked.

FIG. 11 is a block diagram of circuitry that, in some aspects, may be used to implement various functions, operations, acts, processes, and/or methods of inference.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided decision engines that enhance decision quality while minimizing the time and cost of computing resources needed to generate such a decision. Such embodiments may be implemented by instructions for execution by a processor. The instructions may be stored on a non-transitory machine-readable medium. The instructions, when loaded and executed by the processor, may cause the processor to perform the functionality described herein.

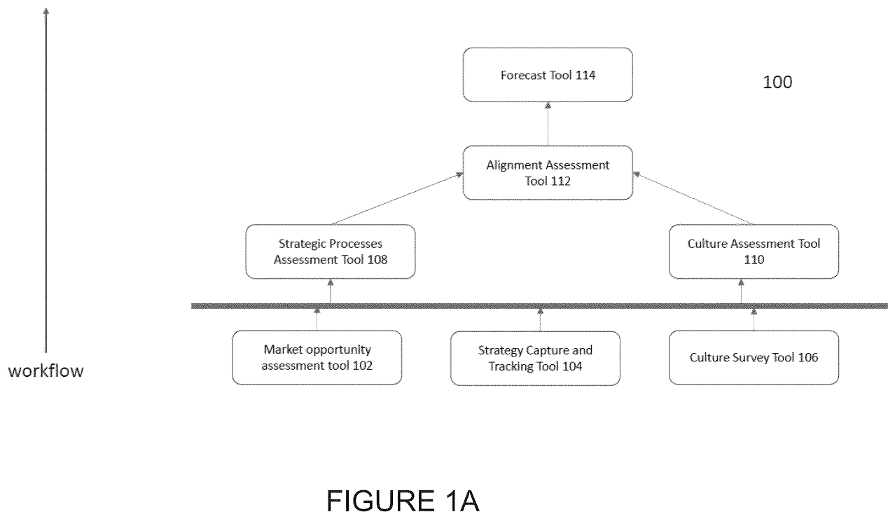

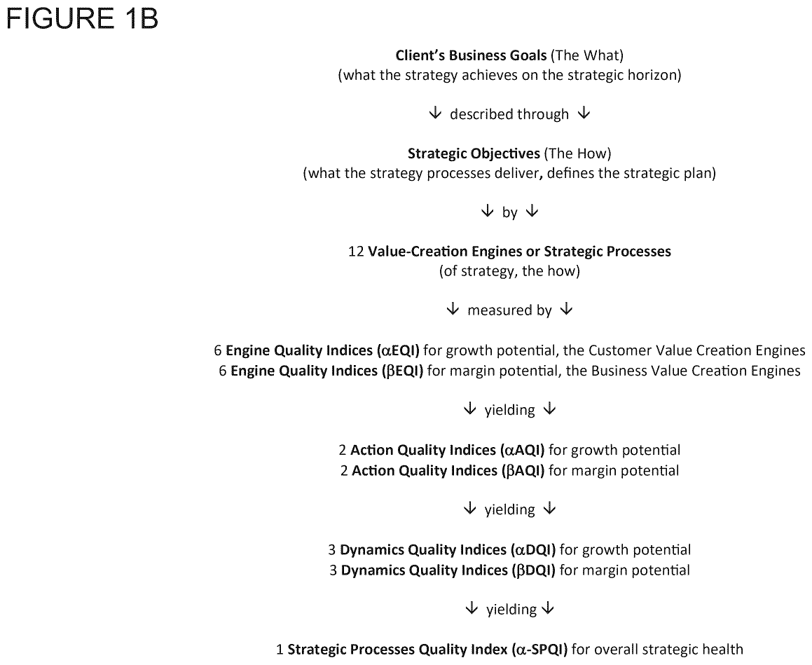

FIG. 1A illustrates a block diagram of an implementation of an inference set 100. Inference set 100 may handle the process of data ingestion, filtering, reduction and storage.

Any suitable number and kinds of mechanisms may be used to input data into inference set 100. For example, inference set 100 may include a market opportunity assessment tool circuit 102, a strategy capture and tracking tool circuit 104, and a culture survey tool circuit 106. Circuits 102, 104, 106 may be implemented in any suitable manner such as by instructions for execution by a processor, a database, or other suitable source of data. Data from circuits 102, 104, 106 may include structured and unstructured data. Data from circuits 102, 104, 106 may be selectively ingested into inference set 100 for use by other components therein. Data from circuits 102, 104, 106 may be ingested, classified, and tagged according to a pre-configured approach. Information from circuits 102, 104, 106 may be typical data that is available, though unstructured and without contextual information such that the data from circuits 102, 104, 106 may be loaded in its entirety, or needed again at later stages of analysis. Information from circuits 102, 104, 106 may be loaded using an extract transform load (ETL) workflow. The ETL workflow may be used to clean, tag, and otherwise prepare data for analytics in the rest of toolset 100. The ETL workflow that is used in a particular application may vary and may be set according to the needs of the application. Data that is to be needed is identified and the remainder is removed or not ingested.

Data from circuits 102, 104, 106 may include presentations from companies, feedback from users on any social media platform, reports from analysts or reporters, or other industry authors, historical financial databases available in EDGAR or aggregators such as the Dow Jones industrial average, pitch books, or FactSET. Data from circuits 102, 104, 106 may include, or may be ingested from, propriety data warehouses and systems.

Once the necessary data is ingested into toolset 100, the data may be loaded into any suitable number and kind of engines. Such engines may be implemented by instructions for execution by a processor. Toolset 100 may include a strategic process assessment engine circuit 108 and a culture assessment engine circuit 110. The strategic process assessment engine, when fully populated, may be a pre-trained, strategy translator, such as StratGPT or ChatGPT. Strategic process assessment engine circuit 108 may represent a combination of any suitable number and kind of filters to act upon data ingested into toolset 100. For example, strategic process assessment engine circuit 108 may include a canonical combination of twelve filters that act on the ingested data including the underlying training parameters that an unsupervised ML model would generate. The twelve filters may represent a baseline set of considerations that may be taken into account for an accurate result to be generated by toolset 100. Culture assessment engine circuit 110 may analyze how individuals may respond in different situations. The combination of these data reduction engines allows the stored information to be significantly reduced compared to the volumes of data fed into the original engines.

Data from organizations may be ingested by strategic process assessment engine 108. Data from users or individuals may be ingested by culture assessment engine circuit 110. Data from organizations may be built upon a model that assumes a process component, wherein the process produces a reproducible set of instructions that produces the same output for the same input, given distribution models, tolerances, and behavior. Data from users or individuals may define how a given set of people will respond to rules or stimulus. This data may include probabilities that different people, experiencing the data of organizations, may actually act the same or differently.

Outputs of engine circuits 108, 110 may include circumplex charts which may include a set of N data points, such as twenty-four, represented in a radial chart. Outputs of engine circuits 108, 110 may also include a set of M coefficients, such as six, to provide data fitting. For example, data ingested into strategic process assessment engine circuit 108 may include historical information from hundreds of companies, which may be reduced in strategic process assessment engine circuit 108 to six coefficients and six data points.

Subsequently, results from engine circuits 108, 110 may be correlated by alignment assessment tool circuit 112. This alignment assessment tool circuit 112 may be implemented by instructions for execution by a processor. Alignment assessment tool circuit 112 may be configured to correlate the results from engine circuits 108, 110 and estimate the probabilities of decision outcomes to be made by forecast tool 114. Forecast tool circuit 114 may be implemented by instructions for execution by a processor.

Alignment assessment tool circuit 112 may correlate the outputs of engine circuits 108, 110. Areas of overlap may be analyzed and produced. Overlaps of results may form an area point of view, and the degree of overlap may be used to evaluate the fit of personal and company data. The analysis may run many times to find the best overlap, which may be reverse-analyzed to identify metrics that should be used for improvement.

Strategic process assessment engine 108 may determine whether a given strategy will prevail over competitors and take market share, or whether current venture processes strong enough to successfully execute a given strategy. Culture assessment engine circuit 110 may determine whether a present culture of an organization is a true strategic advantage, and how exactly strong is a given company culture. Alignment assessment tool circuit 112 may determine whether a company culture aligns with and fully supports a given strategy. Alignment assessment tool circuit 112 may also determine which cultural traits, if strengthened, will have the greatest impact on strategy success. Forecast tool circuit 114 may determine how accurate is a financial forecast over a strategic horizon, accounting for external and internal risks. Forecast tool circuit 114 may also determine how confidence in achieving strategic objectives may be increased.

The strategy capture and tracking tool circuit 104 may include definitions of: Business Goals, Strategic Approach, Strategic Objectives, Success Metrics, Macro Trends, Macro Trends, and Competitor Strategy. Business Goals may include a brief description of what is to be accomplished as a venture. Examples: “Double profits over next three years,” or “Become the number two provider in North America in two years.” Strategic Approach may include a brief description of how to accomplish the Business Goals. Examples: “Disrupt a new market segment with a product line that offers customers higher value for entry-level products,” or “expand into new geographies by leveraging partner sales channels.” Strategic Objectives may include a brief description of specific quantified goals. Examples: “Improve Gross margin by 500 basis points in the first year,” or, “Improve awareness by 25% in Asia by year two.” Success Metrics may include a brief description of key metrics that can be tracked that indicate whether progress is being made on Strategic Objectives. Macro Trends may include a brief description of external positive and negative (headwinds) that impact your strategy. Competitor Strategy may include a brief description of most likely competitor moves.

FIG. 1B shows a flow chart for generating metrics and assessments by the inference set implementation of FIG. 1A.

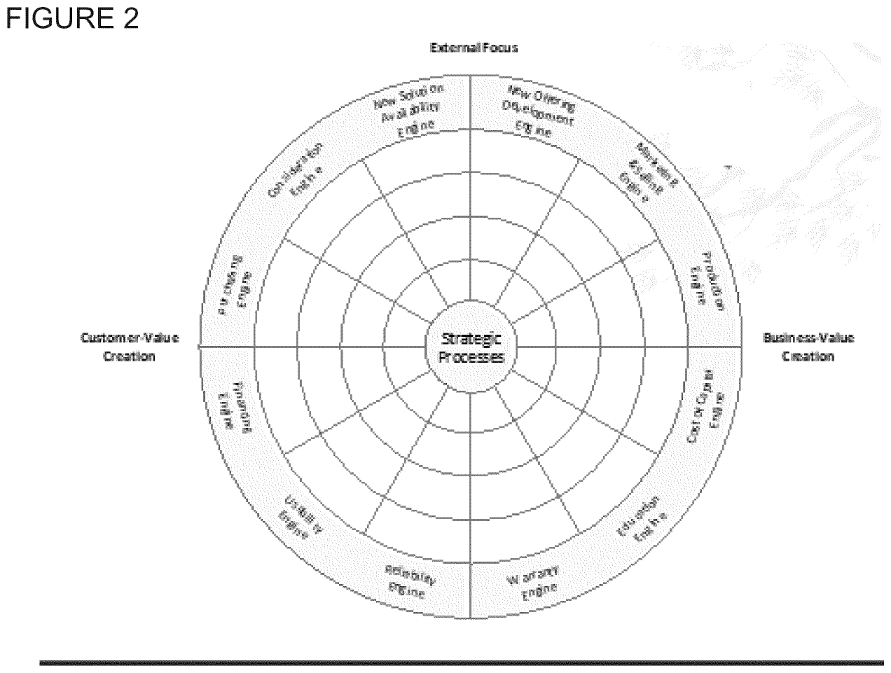

FIG. 2 illustrates one instance of a canonical set of data reduction filters to be used by strategic process assessment engine circuit 108, which may utilize twelve specific data reduction classes and filters (engines). These engines may represent a canonical, or mutually exclusive basis set of filters for a holistic and complete reduction of the data. The filters or engines may include: purchasing, consideration, new solution, new offering development, marketing and selling, production, cost of capital, education, warranty, reliability, usability, and financing. These may be arranged radially as shown with a Y axis that describes whether the data represents a more externally or internally focused strategy, and an X axis that describes whether the data represents an emphasis on customer compared to venture value creation.

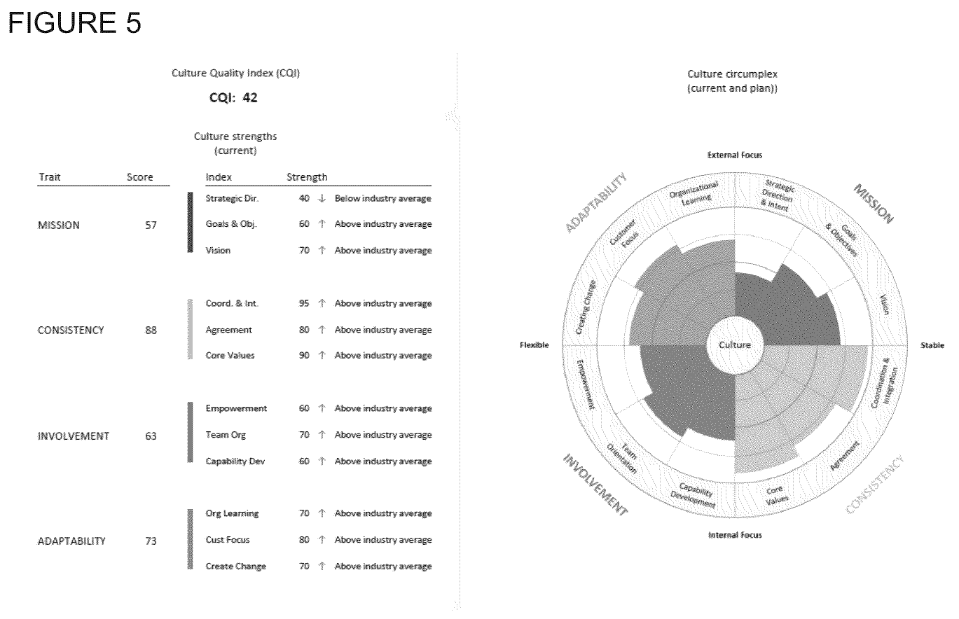

FIG. 5 illustrates one instance of a canonical set of data reduction filters to be used by culture assessment engine circuit 110, which may utilize twelve specific data reduction classes and filters (engines). These engines may represent a canonical, or mutually exclusive basis set of filters for a holistic and complete reduction of the data. The filters or engines may include: strategic direction, goals and objectives, vision, coordination and integration, agreement, core values, capability development, team orientation, empowerment, creating change, customer focus, and organizational learning.

Outputs for each of the twelve classes may be overlaid onto the graph of FIG. 2, which may visualize the output of engine circuits 108, 110.

Each of the engines shown in FIG. 2 may act as repository for rules or data for a given analysis. For example, in the new solution availability engine, a data repository may be implemented to allow users and suppliers to upload and download data on unmet jobs and needs, to enhance that engine's effectiveness for decisions for new solutions.

The engines and filters of FIG. 2 may be identified as the engines and filters needed to accurately model a strategy. Success for a given strategy may be variably defined, and may include numeric goals that are a combination of, for example, revenue, revenue growth, market share, market share growth, profit pool shares, or profit pool share growth. Different entities may use the same measures but may have different goals, and a strategy may be selecting the vectors upon which an entity intends to differentiate itself from other entities. The vectors of differentiation may define a model, and the potential vectors of differentiation may be quantified by these engines and filters to best enable competitive comparisons.

As discussed above, in FIG. 2 the engines or filters on the left may be customer value engines and the engines or filters on the right may be venture value engines. Customer value engines may be based on analysis of typical customer journey frameworks. They may be created by identifying the mutually exclusive decision points for the customer and then representing those as a set of independent variables that characterizes the whole process between wanting something and using something. They may be measured on an absolute scale as the customer's needs can be captured on a normalized scale. Venture value engines may be based on the company's capability and cost to deliver on those customer needs. These may be the mutually independent decision points regarding investments in the venture. These may be measured on a relative scale as it must capture the company's ability to do this relative to the competition.

The external-facing, customer-value engines may improve the customer's pre-sales experience. The internal-facing, customer-value engines may improve the customer's post-sales experience. The external-facing, venture-value engines may improve the company's solution efficiency. The internal-facing, venture-value engines may improve the company's delivery efficiency.

There may be four primary vectors upon which a company can differentiate. The engines of the top half of FIG. 2 may be presales focus, with differentiation through focus on understanding customer needs and serving, including: purchasing, consideration, new solution availability, new offering development, marketing and selling, and production. The engines of the bottom half of FIG. 2 may be post sales focus, with differentiation through focus on serving the customer's usage experience and serving it at lower cost than the competition, including: financing, usability, reliability, warranty, education, and cost of capital. The engines of the left half of FIG. 2 may be customer experience focus, with differentiation through focus on maximizing the customer experience across the entire journey, including: new solution availability, consideration, purchasing, financing, usability, and reliability. The engines of the right half of FIG. 2 may be venture efficiency focus, with differentiation through focus on venture efficiency, including: new offering development, marketing and selling, production, cost of capital, education, and warranty.

### New Solution Availability Engine: EQII=NSA

One of the engines may be a new solution availability engine. It measures how effectively an organization reduces the effort for a customer, or a market, to make their prioritized needs known so that solutions can be developed. Its algorithm may use, for example, Jobs framework of Clayton Christensen and approaches similar to the Outcome-Driven Innovation methodology as described by Anthony Ulwick. This methodology identifies opportunities to better serve customer needs by segmenting the target market by common “jobs to be done”, ranking the importance of customer needs, and grading how well the market serves those needs today. This is typically driven by direct survey techniques but can also be approximated with internal knowledge. Input variables may include customer satisfaction scores, which may be sourced with customer surveys or interviews with product or offering management, sales, or R&D.

The New Solution Availability Engine measures how effectively an organization's Strategic Processes identify solutions that meet customer needs. An organization's NSA process attempts to maximize the solutions customers can use to complete existing and new jobs. The NSA score is a measure of how much the planned product or service features provide all the benefits a customer desires from a purchased solution. If 100% of all customers' needs are met by a solution, then the NSA engine would have a score of 1. The NSA engine metrics quantify how effectively a NSA process gathers inputs-information defining buyer needs, customer outcomes that are underserved or not served-synthesizes them in terms of current or future impact, and guides creation of solutions that can be offered to buyers to address these needs.

An NSA process delivers value to the customer in two distinct ways. First, it defines solutions that meet the buyer's needs, which is the definition of serving a market. This is often associated with an inbound marketing, product management “front end” process if embedded in R&D. Second, it prioritizes the development of the solutions—which is the input to the R&D team in the NOD engine—to maximize share capture because the most important benefits are being prioritized. The outcome opportunity scores may be similar to the ODI methodology as described in Ulwick, “What Customers Want,” as the method to measure the faction of the benefits a solution provides

As revenue is typically a key “What” or goal for a company, there is often a benefit to express the NOD score as a market size as they are proportionally related. This can be done if it is possible to define the proportion of the market value is associated with specific discrete combinations of features. Alternatively, one could do it based on the ration of the opportunity scores per the ODI Methodology but that again is proportional as it assumes that linear relationship between the opportunity score and a portion of the market.

A set of Outcome Driven Innovation (ODI)—like Scoring processes may be used. Markets can be scored at the Jobs, Outcomes, and Outcome-segment hierarchies. Attractiveness of a market is a combination of the size, growth rate, opportunity score (which is the number of unmet needs that can be addressed) and offerings that an organization has compared to competitors. There is a top-level split in the algorithm for Business to Consumer (B2C) and Business to Business (B2B) markets. The process will not initially be used for C2C markets other than the intermediary platforms such as e-BAY or Etsy.

Business to consumer markets: Organizations can use any segmentation model that is based on the traditional attributes such as products, regions, or industries. In business to consumer markets, organizations can also employ a full outcome-based segmentation model as taught by Strategy that provides a needs-based segmentation model developed on the basis of the results of an ODI survey. This approach is suitable for business to consumer businesses as we can assume that marketing is heavily awareness-based.

Business to business markets: These markets can also use either traditional segmentation attributes or an ODI-like outcome-based segmentation when defining market attractiveness. However, in many cases, the outcome-based segmentation will produce phantom segments that technically exist from a survey perspective but cannot be cost-effectively reached or targeted. Consequently, segmenting and sizing these markets will be limited to traditional demographic attributes, which may have the effect of lowering the attractiveness scores of the markets.

An example of this type of market would be portable disk drives. Portable disk drives are needed by individuals, and needed by both small companies and global enterprises, but for many different reasons and with very different requirements. An ODI segmenting model would aggregate this type of buyer as one market segment, but as the segment is distributed across so many other attributes (geographic location, storage size, price, quality, MTTF) it would not be feasible to develop a single, homogenous set of actions to gain share in the “portable disk drive market.”

The absolute NSA score is estimated as the customer's responses to the question of how well does a product address your needs or requirements, where a score of 1 would represent 100% satisfaction and zero (0) would be no satisfaction, or in the case of an unsupervised ML model, the results of a fully trained set of responses

$$NSA = \frac{1}{M} {\sum }_{m = 1}^{M} [ \frac{{MarketSolutionScore}_{m}}{{MarketODIScore}_{m}} ]$$

Wherein MarketSolutionScoreₘ is the estimated ODI opportunity score for a proposed innovation solution in the m^{th} target market segment. For details on how to calculate this, read the Juniper Strategies ODI primer, and MarketODIScoreₘ is the total market opportunity score. If one has access to the market size data, this can also be normalized as

$$NSA = \frac{1}{M} {\sum }_{m = 1}^{M} [ \frac{{MarketSolutionScore}_{m} * {SolutionValue}_{m}}{{MarketODIScore}_{m} * {MarketSize}_{m}} ]$$

### Consideration Engine: EQI2=CON

One of the engines may be a consideration engine. It measures the effectiveness of an organization to help buyers or users become aware, consider, and eventually select or decide to purchase a specific solution to accomplish their job from a wide variety of potential offerings. This engine combines awareness of the brand and its collection of offerings, and preference (equity) of brand and channel, into one overall metric. Awareness is simply how aware the target market is of the target offerings and the organization overall (typically surveyed). Brand equity is the trust the target market customer has in the company's ability to deliver the expected outcomes, and channel equity is the equivalent for the company sales representative or channel to communicate these outcomes. The data typically comes from surveys that are similar to net promotor score (NPS) surveys or internal estimates.

One of its input variables may be awareness, the unaided awareness of the organization (survey technique). One of its input variables may be Offering Awareness, the unaided awareness of the existing or proposed offerings in a target market. One of its input variables may be brand equity of the company. These three may be typically done through a brand survey or Company Estimates. One of its input variables may be channel equity of the company. This may be sourced through a proprietary survey, typically added to the customer survey or Company Estimates.

This engine measures the effectiveness of an organization's process to help buyers or users become aware, consider, and eventually select or decide to purchase a specific solution to accomplish their job. The purpose of the associated strategic processes is to maximize the ability of the customer to choose the best solution.

Anytime a consumer or business buyer wants to spend money to satisfy their needs, they research what is available, compare the set of competitive offerings and make a choice. This is a time consuming, thus costly, process to a buyer. Companies create value when they help a customer have confidence or trust in the information they have been provided and in their eventual decision. Quantifying this customer benefit is the basis for the Consideration Engine Score. This engine measures how well an organization's marketing and sales processes reduce the time and effort it takes a potential buyer to research and become aware of the existence of a solution to their unmet needs, compare alternatives and trust the decision they are making.

Data related to the brand, offering awareness, and brand/channel preference (equity) may be averaged into one overall metric. The organization's awareness—which is the percentage of the buying population that is familiar with the company—may be combined with the offering awareness-which is the percentage of the buying population is aware of the existence of a specific offering with the preference for the brand and the channel which is the proxy for the trust a buyer has in the decision they are making and is obtained with a survey technique including on-line responses for e-commerce channels. The brand and channel equity pieces are used specifically as in many buying situations, the buyer does not have the technical ability to evaluate and validate the claims made by the marketing or selling processes and thus must rely on the experience they had during previous interactions or from others. This is why e-commerce recommendation scores are so critical to providing value here.

The two awareness components are simply achieved through surveys of small samples of customers to estimate overall effectiveness. The preference scores also use an assumption that a survey technique or a web-based assessment equivalent, a brand equity and channel equity score are estimated. Both the Brand Equity and Channel Equity can use a number of different survey types, including normalized NPS or techniques known in the field.

Brand or Channel Equity is the response to the following type survey question: How much do you trust the Client Company (Brand) or Client Company Sales Representative (Channel) to deliver the expected outcomes on a scale from 1-10

The Consideration engine CON score is calculated as a simple average of these survey response scores or in the case of an unsupervised ML model, the results of a fully trained set of responses

$$CON = \frac{1}{3} ( \frac{OrganizationAwareness [ \% ]}{100} + \frac{1}{100 * M} {\sum }_{m = 1}^{M} {OfferingAwareness}_{m} [ \% ] + [ \frac{Be + Ce}{2} ] )$$

Where OrganizationAwareness is the unaided awareness of the organization (survey technique); OfferingAwarenessₘ is the unaided awareness of the m^{th} proposed offering in a target market; Be is the brand equity of the client company brand which is a number between 0 and 100%; Ce is the channel equity of the client company field channel which is a number between 0 and 100%.

### Purchasing Engine: EQI3=PUR

One of the engines may be a purchasing engine, which measures how easy the organization makes the purchasing process for the customer-finalizing the purchase, the ability to return if the decision was later judged wrong, the timeliness of delivery, and whether it arrives meeting quality expectations. This engine intakes the NPS-like survey score for purchasing ease, divergence from requested or expected delivery date, and quality of offering when it is first used or consumed.

Its input variables may include purchase ease, which may be an NPS-like survey score, typically done through a survey or Company Estimates. The input variables may include DLP, which is the percentage of deliveries that are early or late from the customer request date, which may be derived from internal company data from Operations. Many companies have a hybrid which can be used for an estimate. The input variables may include Offering Quality, which may be derived from customer complaint, customer return or survey data from the operations, quality or customer success team. Preference may be given to customer survey data.

The Purchasing Engine estimates an organization's processes and capability to maximize the convenience, timeliness and confidence (Minimizing risk) of a customer when they are purchasing a solution.

The value the processes associated with this engine create measure the ease of finalizing a purchase once a solution choice or decision has been made—which was measured in the previous engine—of the ability to make returns if the solution decision was judged wrong, the timeliness of the purchase which is measured to the customer's requested date and does it arrive meeting all expectations which is a quality metric.

For the ease of purchasing and returns, it is possible to use a survey technique. This is then combined with the Quality metric which is obtained based on reported out of the box or initial failures or bug reports and finally the accuracy that the solution is delivered on the requested date, recognizing that early delivery is also undesirable. The three components are averaged together in a first instance of the algorithm.

The score for the Purchasing Engine PUR is calculated as an average of survey responses to these questions or in the case of an unsupervised ML model, the results of a fully trained set of responses or in the case of an unsupervised ML model, the results of a fully trained set of responses

$$PUR = \frac{1}{3} [ ( \frac{PurchaseEase}{200} ) + ( DLP ) + ( \frac{Quality}{2} ) ]$$

Where PurchaseEase is the survey score for customers purchasing from the client company. DLP is the survey score for delivery satisfaction. Quality is a customer score of perceived quality using a survey of their delivery experience

### Financing Engine: EQI4=FIN

One of the engines may be a financing engine, which may assess how well customers can maximize their ROI on getting their outcomes or needs met. The first component of the metric is dependent on the price a company charges customers to transfer the value. The second component is associated with any financing companies provide. There are two components to the cost a customer pays for the value they receive: the price that a customer pays, and the financing a supplier extends to the customer which allows them to derive the benefits sooner than they could without the financing. This is also balanced with the COGS and loan costs that the company incurs to provide the offering and extend financing The algorithm does account for companies transferring value at a financial loss which can be a temporary market share gain tactic.

Its input variables can include ASP or COGS (by offering, market segment, or business based on level), and may be sourced by offering or product management records, sales operations, or manufacturing operations. Its input variables can include financing terms and costs, which may be sourced by typical credit terms and rates extended to customers and for servicing these credit facilities.

This engine assesses the process that an organization uses to create value for customers in terms of both the price that they use to transfer the value to the customer and any financing they provide to enable their customer to purchase the benefits while separating their ability to earn or have the wealth needed to purchase the solution.

The other five customer value creation engines measure the value that is created for the customer in terms of benefits. This engine defines the financial terms of the value transfer. There are two components to this value, the price that a customer pays, and the financing a supplier extends to the customer which allows them to derive the benefits sooner than they could without the financing.

Overall, it would be possible to consider both the price and the financing as part of pricing, but we are separating them to account for the significant difference in value when loaning money as it makes assumptions on future values and introduces a level of uncertainty that needs to be modelled into the company's strategic plan. For the first component, the maximum value occurs when the price is zero, meaning the benefits are provided for free (We are going to assume there are no or very few cases where the vendor would provide the customer with cash in addition to charging a zero price so there is a floor to the price of zero). In this case, the score would be greater than zero, which is acceptable as it is an interesting economic case of giving the customer benefits for no economic value in return. The second component is the financing, which is simply the portion of the price that is provided for a fixed cost over a period of time which is the interest expense over the life of the loan. For a loan that charges no interest and the principal repayment is extended forever, the loan value is a maximum and would be the financing equivalent to zero price. In one instance, customers would be surveyed on a 1-10 scale on whether pricing and financing terms meet their needs or in the case of an unsupervised ML model, the results of a fully trained set of responses or in the case of an unsupervised ML model, the results of a fully trained set of responses

The FIN metric can be calculated as an average of the customer responses or in the case of an unsupervised ML model, the results of a fully trained set of responses

$$FIN = \frac{1}{2} ( \frac{1}{( 1 + \frac{Price - COGS}{COGS} )} + \frac{1}{( 1 + \frac{InterestExpense - LoanCost}{Loan Cost} )} )$$

Where price is the average selling price charged to the customer for all products, COGS is the average cost of goods sold (COGS) for all the products, InterestExpense is the interest expense charged to the customer over the life of the loan, and LoanCost is the cost to the supplier to provide and service the loan. This is not the principal amount.

### Usability Engine: EQI5=USA

One of the engines may be a usability engine that measures whether the value delivered by an offering is always available to the customer, or if there are any limitations. It also measures how well a customer can use what they purchase and how long it takes them to gain that proficiency in the offering, which is a time delay in receiving the full value of the offering. This engine looks at the features, or aggregated feature level of offerings in market segments and determines if there is any amount of time that the full value is not available when the customer desires it. An outage period of any social media platform or app is an example of a loss of value to the customer. The second component is for those offerings that require any form of training, learning or education, representing time and possibly money invested by the customer to acquire benefits they have previously paid for.

Its input variables can include the availability of offering, which may be the percentage availability an offering is delivering full benefits to a customer. The input variables can include user benefits, which may be the percentage of user benefits a customer can receive or enjoy as a function of the training or support they have received to that point in time. The source of these may be customer service or customer success records.

The usability engine estimates how well a customer is able to use what they purchase. This measures an organization's strategic processes' ability to maximize the benefits a customer derives from their purchased solution, especially in the case of the customer needed to be trained to begin deriving benefits of the purchased solution.

Depending on the scale, diversity, operational requirements, and complexity, the customer may need to invest time and resources to use (set-up and get trained) to gain the full benefits of the purchase once it has been delivered. This would also include installation and other one-time costs associated with beginning use of a solution.

The primary metric for useability is proficiency-how well a customer can achieve all the outcomes of their purchase. Proficiency measures the reduction in the buyer benefit associated with the additional costs and time incurred by a buyer to gain the information and master the ability to use the offering. Until a buyer has achieved proficiency, the benefits they receive are reduced from their expectation. In this way of thinking, proficiency becomes a relative percentage score that compares the % of benefit actually received compared to expected and thus can be used to estimate a relative score. Something with instant usability, would score 100%. Something that reduces the buyer's benefit by 1 year, for something they expect to use for three years, would be modelled as ⅔ (66.7%) proficiency.

The usability engine score USA is calculated as an average of customer survey responses to a question on useability or in the case of an unsupervised ML model, the results of a fully trained set of responses or in the case of an unsupervised ML model, the results of a fully trained set of responses

$$USA = \frac{1}{200 * M} * {{\sum }_{1}}^{M} [ {Availability}_{m} + \frac{1}{J} {{\sum }_{j = 1}}^{J} {UserBenefits}_{m} ]$$

Where M is the number of offerings, Availability is the % availability an offering is delivering benefits to a customer at full proficiency, UserBenefits is the % of user benefits a customer can receive as a function of the training or support they have received to that point in time, and J is the number of outcomes that a customer would be measuring in terms of satisfaction. If the customer cares only about one benefit, then J is 1. If the customer cares about and measures multiple benefits for the same offering and would be aware that he was not deriving the benefits, then J is greater than 1.

### Reliability Engine: (EQ16=REL)

One of the engines may be a reliability engine that assesses whether the value a customer pays for decreases or erodes over their lifetime of their using an offering. This engine uses data from repair, maintenance or failures, to measure the amount of value that is lost by the customer over time. If any failure or degradation in performance is remedied by the efforts of the company, the reliability scores are adjusted to reflect these repairs. Any downtime associated with the repair is also factored into the overall metric.

Its input variables can include availability over time, which may be the availability of the [offerings, market segment composite, Business Unit composite] per year over the expected product lifetime, once user has been completely trained in how to use the offering. The source of these may be customer service or customer success records.

This engine assesses the process that an organization uses to maintain and maximize the value for customers over their lifetime of using an offering.

This engine applies to offerings where some fraction of the original benefits or value that was purchased by and delivered to the buyer, is not available, including if the benefits erode over time. The buyer is assumed to retain the original need or that his needs reduce at a known rate (expected depreciation), and so value must be recreated and redelivered to the buyer while the benefit expectation exists. Included is general maintenance, repair, and refurbishment within an agreed upon window of time. These are often defined in an offering's warranty, but also as service. When including service, this does not include typical routine service and maintenance that the customer expects to purchase, such as an oil change for their car.

The Reliability metric score is estimated as the availability of the solutions benefits over the lifetime of use.

The reliability engine score REL is calculated as an average of the responses of a customer survey or in the case of an unsupervised ML model, the results of a fully trained set of responses

$$REL = \frac{1}{J * M * 100} * [ {{\sum }_{m = 1}}^{M} {{\sum }_{j = 1}}^{J} {Availability}_{j , m} ]$$

Where Availability is the availability of the m^{th} offering in year j, once user has been completely trained, M is the number of offerings, and J is the number of years a product is expected to provide benefits to the customer.

### Warranty Engine: EQI11=WAR

One of the engines may be a warranty engine, which may measure an organization's process and ability to provide repair or maintenance services to a buyer when the offering fails to deliver the promised value. This engine looks at the company's expense to improve, fix, or otherwise deliver on any gaps in the promised value for which the customer paid. This excludes paid warranty contracts and instead is focused solely on costs that are not directly billed to the company's end-customers.

Its inputs may include free service costs, which may be the typical costs, as a percentage of the purchase price, to service or otherwise deliver extra benefits to the customer for which there is no charge for the offerings. This may be sourced by Product Management or Customer success organization and estimates or benchmarking financially of peers.

The purpose of this engine is to measure an organization's process and ability to provide repair or maintenance services to a buyer when the offering fails.

There is a spectrum of failure rates for offerings that will require the original selling organization to take possession of the offering and modify it in some way, including the option of replacing it. The strategic advantage is how quickly and cost effectively an organization can diagnose root cause, repair and return an offering. For software, this would include updates that fix problems, but not those that incrementally improve performance or add features. In aggregate, this is considered part of warrantying the quality of the solution.

There are different ways that organizations measure the costs of providing warranty service, especially depending on whether it is paid or not. Overall, we are measuring the organizations need to provide service value for free. Similar to the EDU engine, if there is an explicitly understood and separately marketed and sold revenue producing service, maintenance or warranty (insurance) offering or solution, then we should consider that value as part of the NSA and NOD engines

The warranty engine WAR score is calculated as the operational leaders estimate of the % of Revenue that is invested in warranty costs normalized to peer competitors in the industry or in the case of an unsupervised ML model, the results of a fully trained set of responses

$$WAR = \frac{1}{M} {{\sum }_{m = 1}}^{M} OSC ( {FreeServicesCosts}_{m} , {BOS}_{m} )$$

FreeServiceCostsₘ is the typical costs, as a percentage of the purchase price, to service or otherwise deliver extra benefits to the customer for which there is no charge for the m^{th} offering. FreeServiceCostsIndustryₘ is the industry average costs, as a percentage of the industry average purchase prices, to service or otherwise deliver extra benefits to the customer for which there is no charge for the m^{th} offering.

### Education Engine: EQI11=EDU

One of the engines may include an education or training engine, which may measure the efficiency of an organization's strategic processes to inform, educate, and train customers in the successful adoption and use of their offering so they receive full value. This engine uses the company expenses on post sales training, education, and related materials costs. These are compared to industry averages for similar offerings.

Its inputs may include training costs, which are associated with delivering a first pass success training of the offerings and enabling 100% of the benefits to a customer. It may be sourced by Product Management or Customer success organization and estimates or benchmarking financially of peers.

The purpose of the customer Education Engine is to measure the efficiency of an organization's strategic processes to inform, educate, and train customers in the successful adoption and use of their offering.

For many offerings, the customer must be taught how to receive the complete set of benefits delivered by a specific offering. There are specific cases where training is a requirement for which customers must explicitly pay. In this case, this would be outside the realm of this process/metric set and would be captured in the NSA and NOD offerings. By shifting value creation between the different engines, different business model strategies may be captured.

This is the cost-to provide the training compared to the industry average for competitive offerings. The case where the customer pays for training or other elements of the value that is associated with this engine do not change the effectiveness metric but are removed from the cost efficiency metrics.

The Customer Education engine efficiency EDU score is the training leaders estimate of the % of Revenue that is invested in training customers normalized to peer competitors in the industry or in the case of an unsupervised ML model, the results of a fully trained set of responses

$$EDU = \frac{1}{M} {{\sum }_{m = 1}}^{M} OSC ( {OfferingTrainingCosts}_{m} , {BOS}_{m} )$$

OfferingTrainingCostsₘ is the training cost associated with delivering a first pass success training of the m^{th} offering and enabling 100% of the benefits to a customer. This is normalized to the average offering cost. IndustryTrainingCostsₘ is the industry average for the training costs associated with delivering a first pass success training of the m^{th} competitive offering and enabling 100% of the benefits to a customer. This is normalized to the industry average offering cost for the m^{th} offering. M is the number of offering.

### Cost of Capital Engine: EQI10=COC

One of the engines may be a cost of capital engine, which may measure an organization's ability to finance the operations of its venture, including the tax rates they pay. This is the company's ROI metric components. This engine uses the working cost of capital and weighted tax rate relative to the competitive (industry) average. This engine captures the key components of working capital and the aggregate tax rates to compare the impact of geography strategy.

Its inputs may include WACC, sourced by finance team and estimates or benchmarking financially of peers; and tax rates, sourced by finance team and estimates or benchmarking financially of peers.

The purpose of this engine is to measure an organization's ability to finance the operations of its venture, including the tax rates they pay. This engine captures the key components of financing working capital and the tax rates.

Operating a venture, both to finance working capital, extending financing to customer and paying taxes are the three components that represent the mutually exclusive components of Cost of Capital.

Each of the components of the financial operating structure are compared to industry average. These are used to estimate the income statements

Cost of Capital is measured as the finance leaders estimate of the WACC and Tax rates for the company normalized to peer competitors in the industry or in the case of an unsupervised ML model, the results of a fully trained set of responses

$$COC = \frac{1}{2} ( OSC ( WACC , BOS ) + OSC ( Tax , BOS ) )$$

WACC is the company's weighted cost of capital. WACC_{industry} is the industry average weighted cost of capital. BOS_{WACC} is the BOS ratio for WACC. Tax is the company's weighted tax rate. Tax_{industry} is the industry weighted tax rate. BOS_{TAX} is the BOS ratio for Tax rate.

### Production Engine: EQI9=PRD

One of the engines may be a production engine, which measures the company's ability to produce/manufacture and deliver its solutions to customers in a timely and cost-effective manner. This engine captures the creation and delivery of hardware, software, or service experiences. This engine measures the efficiency of the production and delivery processes using the gross margin per offering and delivery cost per offering, relative to the competitive (industry) average.

Its input variables can include offering gross margins (GMs), sourced by offering or product management records, or operations records and estimates or benchmarking financially of peers; and delivery costs, which may be sourced by sales or operations financials and estimates or benchmarking financially of peers.

The purpose of the production engine is to assess an organization's strategic processes and ability to produce or manufacture and deliver an organization's solutions to customers in a timely and cost-effective manner. Production captures the creation and delivery of hardware, software, or service experiences, such as the case of a retail business.

All organizations that produce a solution, whether it has hardware, software, or service components, must be able to do so at a scale that allows them to meet the demand created by the selling engines. The ability to produce and deliver a solution on time, with no quality defects, are the primary sources of strategic advantage delivered by the production engine. In this model, purchase of component supplies is considered a portion of the manufacturing engine.

The algorithm for the production engine looks at the two cost components for the production and delivery of the solution compared to industry benchmarks. Each of these can be made up of several subcomponents, as manufacturing processes tend to have multiple value-creating steps. More detailed models will incorporate the entire value stream map of a manufacturing process to identify waste. Directionally, an organization wants to asymptotically move yield higher, and the combined costs lower. Similarly with the delivery costs. The PRD engine efficiency score is simply an average of the relative COGS (Estimated as Gross Margin) for each offering compared to competitive offerings and the Delivery Costs

The Production engine score PRD is calculated as the operational leaders estimate of the % of Revenue that is invested in production, including cost of goods that are inputs to manufacturing normalized to peer competitors in the industry or in the case of an unsupervised ML model, the results of a fully trained set of responses

$$PRD = \frac{1}{2 * M} {{\sum }_{m = 1}}^{M} OSC ( {OfferingGM}_{m} , {BOS}_{m} ) + OSC ( {DeliveryCost}_{m} , {BOS}_{m} )$$

OfferingGMₘ is the gross margin of the m^{th} offering. IndustryGMₘ is the industry average gross margin for the competitive offering to the m^{th} offering. This can also be limited to a specific competitive offering from a single competitor. BOSm is the BOS Score for Offering GM. DCost is the organizations unit delivery cost for an offering. DCostIndustry is the industry's average delivery cost for a competitive offering. BOSₘ is the BOS Score for delivery costs. M is the number of offerings that make up the strategic analysis.

### Marketing and Selling Engine: EQ18=SEL

One of the engines may be a marketing and selling engine, which measures the capability of the organization to reach and persuade the buyers in a market to make a purchase. This engine measures the cost efficiency of the company's tactics and processes to target an individual contact. It aggregates the average “cost per order dollar” for each of the channels a company uses. This is normalized to the revenue through a channel and then compared to competitors or industry averages.

Its input variables can include targeting costs per individual selling entity, sourced from sales or Marketing function financials and estimates or benchmarking financially of peers; and CPOD (Cost per Order Dollar) per channel, sourced from sales or sales operation financials and estimates or benchmarking financially of peers.

This engine measures how efficiently an organization's internal processes can reach and persuade the buyers in a market to make a purchase.

Once an organization has identified attractive markets, and has developed a solution that serves the market, they need to reach and persuade potential buyers to purchase their solution. This is often referred to as targeting and persuading a customer in a market. This is a combination of an organization's marketing and selling processes with the combination being heavily dependent on the portfolio of channels an organization uses to reach its customers. Channels include direct, indirect and electronic (Web or D2C) marketing and selling channels.

This engine measures the effectiveness of these two related and often overlapping processes, outbound marketing and selling. The overlap is because of the relative contribution of the two functions that are often degenerate. Over time, we expect our ML models to identify a clearer distinction between these two sets of internal processes. The combination of these is compared to the industry average normalized for the markets a company plays in. This means that if two companies play in overlapping but not identical markets, we need to estimate the relative spend in the overlapping markets to appropriately capture the efficiency of a company's processes. There is also overlap because there is often channel overlap where two or more selling channels may be reaching a customer and thus, they could be spending more than a theoretical minimum cost to reach and persuade a specific customer. This can be built out in the roadmap for this engine.

The Selling Engine score SEL is written as the Sales and Marketing leaders estimate of the % of Revenue that is invested in sales and marketing normalized to peer competitors in the industry or in the case of an unsupervised ML model, the results of a fully trained set of responses

$$SEL = \frac{OSC ( TargetingCost , BOS )}{2} + \frac{OSC ( {\sum }_{j = 1}^{J} {CPOD}_{j} {RevC}_{j} , {CPOD}_{I} {RevC}_{I} , BOS )}{2 * J}$$

Where TargetingCost is the organization's cost of targeting an individual contact. TargetingCostIndustry is the industry average cost of targeting an individual contact. J is the number of channels. CPOD; is the cost per order dollar of channel j. RevCⱼ is the percentage of revenue sold through channel j. CPOD_{I} is the competitor of industry total CPOD. RevIⱼ is the average percentage of revenue sold through channel j for the industry. BOS is the CPOD power BOS score. For the client company, we compute an actual CPOD by sub-channel and compare it to the industry average. There are a number of component processes that can be used to disaggregate the CPOD metric, which may be helpful when considering the efficiency of different channels and different markets (B2C, B2B and D2C).

### New Offering Development Engine: EQI7=NOD

One of the engines may be a new offering development engine, which measures what is typically considered R&D or development efficiency and inbound marketing efficiency, relative to the competition. The goal may be to minimize the cost and time to develop a solution. This engine works on three parameters. The first is the cost to identify target market needs, typically in an ODI-like or similar market research study, to drive the New Solution Availability Engine (Value Engine 1). Next, development costs normalized to the target market SAM expansion are considered. Third, time to develop and deliver the value to the customer from the time that the need is identified are considered. All of these may be measured relative to the competition.

Its input variables can include Market Research Costs, sourced from product or offering management function financials and estimates or benchmarking financially of peers; R&D Costs (per Market segment) sourced from product management or R&D financials and estimates or benchmarking financially of peers; and R&D Cycletime, sourced by R&D project management files and estimates or benchmarking financially of peers.

This engine measures the efficiency of an organization's processes to identify and develop a solution to the needs of a market-segment. This engine measures what is typically considered R&D and inbound marketing efficiency. The goal of an organization is to minimize the cost and time to develop a solution.

The ability and more importantly from a financial perspective, the efficiency of creating a solution to meet the needs of a market has three key components, the overall cost to identify needs and define a solution, the costs to develop a solution and the ability to deliver to the market need date. The ability to develop and deliver a solution with, in the limit, zero lead time would allow a company to maximize responsiveness to changing market needs. This is balanced by the cost to develop the final solution. Both components are modeled in this engine.

The algorithm has the three primary components. The first is the market needs identification efficiency. This is related to the time and the cost to decide what solution to develop or how effectively an organization can identify pockets of growth it can serve. The comparative benchmark is $1500/respondent for a statistically rigorous ODI survey. If a firm is completing market research above this benchmark, then their operating effectiveness is disadvantaged to the competition. If it is equivalent, then they have parity performance. If they are significantly below this threshold, they are advantaged. Part of the cost associated with developing market knowledge is gaining access to a suitable customer set. For the B2C markets, where targeting costs are lower—because of loyalty or identify programs—the efficiency score may be increased compared to a competitor that does not have these capabilities. The second component is the typical R&D costs. The R&D Costs are normalized to the Market SAM, as it is a question of how efficiently R&D is being spent to capture revenue in a specific SAM. If a company has 2× the R&D, but is developing products that address 2× the SAM, then they are equally efficient. The final component is the cycle time. This is ideally the median cycle time to eliminate the effects of large programs or breaking large programs into small ones. The cycle time is measured in terms of the value delivered to the customer from the time that the need is identified. These three components may be averaged together into one top level NOD score.

The NOD engine score is estimated as the R&D leaders estimate of the % of Revenue that is invested in product development normalized to peer competitors in the industry or in the case of an unsupervised ML model, the results of a fully trained set of responses

$$NOD = \frac{1}{3 * M} [ {{\sum }_{m = 1}}^{M} OSC ( {MarketResearchCosts}_{m} , {BOS}_{m} ) + OSC ( {MarketRDCosts}_{m} , {BOS}_{m} ) + OSC ( RDCycletime {,}_{m} {Bos}_{m} ) ]$$

MarketResearchCostsₘ is the cost to conduct a specific market research project for the m^{th} offering. MarketResearchIndustryCostₘ is the industry average cost to conduct a specific market research project for the m^{th} offering. MarketRDCostsₘ are the organization's R&D costs, normalized to SAM. MarketIndustryCostsₘ is the industry average R&D costs, normalized to SAM. RDcycletimeₘ is the company's median project cycle time for offering m. RDcycletimeindustryₘ is the industries median project cycle time for offering m. In the case that the development methodology is agile for SW, the relative comparison would be sprint velocity, although this would be difficult to capture for competitors in detail. M is the number of offerings under consideration.

Returning to FIG. 2, to assess the fit a culture to a strategy, quantifiable culture measurements can be cross-correlated to strategy engine measurements.

Entities desiring or scoring high in a given each of the four strategy engine differentiation vectors defined in FIG. 2 by a grouping of engine results should ideally be identified as being correlated. Meaning scoring appropriately high to the related sets of cultural attributes of the entity. For example, entities scoring high in assessed or goal results for engines arranged in the top half of FIG. 2 would have a strategy that relies on differentiation in presales processes and behaviors, with differentiation through focus on understanding customer needs and serving them at lower cost than the competition. This differentiation is best supported by an organization with assessed or goal results of its cultural attributes with an external focus, with an ability to adapt and change to the market, with the result to grow as they meet the current and future needs of the marketplace.

Entities scoring high results for engines arranged in the bottom half of FIG. 2 may be a post-sales focus, with differentiation through focus on serving the customer's usage experience and serving it at lower cost than the competition. This differentiation may manifest in cultural attributes with an internal focus on the alignment of internal systems, processes and people of the organization, which may predict efficient operating performance, higher levels of quality and increased employee satisfaction with focus on serving the customer's usage experience and serving it at lower cost than the competition.

In similar fashion entities desiring or scoring high results for engines arranged in the left half of FIG. 2, which is described as a customer-experience focus, with differentiation through focus on maximizing the customer experience across the entire process. This differentiation is best supported by an organization with assessed or goal results of its cultural attributes with being flexible, and being strong in traits that can change quickly in response to their environment, tending to be successful at being innovative and satisfying their customers.

Entities desiring or scoring high results for engines arranged in the right half of FIG. 2 which is described as a venture efficiency focus, with differentiation through being focused and having some level of predictability. They know where they are headed and have the tools and systems in place to get there. They create alignment that results in efficient, profitable performance

For example, compare a high-end restaurant with a fast-food restaurant. The high-end restaurant may score higher on the top half of the engines compared to the lower half, in contrast to the fast-food restaurant. The high-end restaurant may deliver a customer-focuses, individualized service experience with an engaged and dedicated staff. The fast food restaurant may use a strategy with small menus, repeatable preparation, and serving processes optimized for speed and efficiency with a large organization of interchangeable employees. The cultures and strategies of the two restaurants could not be swapped successfully.

Returning to FIG. 2, strategic process assessment engine 108 may assess an organization's strategy by using algorithms to calculate the quality/strength of the strategic processes that power the customer-value-creation and venture value creation engines of the organization. The measure of the quality/strength of these strategic processes may be dependent on the principle that strategic success is defined as taking market share.

Taking share, as a measure of strategic processes success, works equally well in both growing and declining markets. In strong markets it avoids the illusion of success when an organization achieves growth of the type described as “a rising tide lifts all boats.” In a declining market it avoids not recognizing strategic success that may actually be occurring but is masked by falling revenues. If a strategy is successful, an organization will take share regardless of market conditions, and it is this characteristic that makes “taking share” particularly useful as a measure of strategic success.

Moreover, a second metric that is often defined as a measure of strategic success is profitable growth or gaining share profitably. The choice to gain share profitability may be considered as defining an organization's goals. There are many situations where an organization's owners (shareholders), choose to invest in the strategy that is not profitable for some period of time. They may define goals such as market dominance or gaining a first mover advantage and do so by investing at a rate that is not profitable.

The customer value creation engines (those arranged on the left side of FIG. 2) measure the total value that is created and delivered to a customer. These are absolute scores, as each process is defined in terms of a gap to a perfect process. The assumption is that a venture that delivered total value in every engine would win market share. If two or more businesses have the same score, then they are most likely to split the market share proportionally.

The Business Value Creation engines (those on the right side of FIG. 2) measure the efficiency of how well the venture creates the customer value. This makes them a matched set.

The second set of value-creation indices are how the venture organization creates business-value internally. This assesses the operational value a venture creates for its stakeholders compared to other business. These are efficiency score metrics as they can only be computed relative to competitors or markets and efficiency is determined by unit of value created divided by cost.

Since it is presumed that performance greater than the market average will result in taking share, it is important that the definition of “market average” reflect the size of competitors. For example, consider a market where one competitor has 90% of the market, and there are many “ankle-biter” competitors making up the remaining 10%. A simple unweighted average of the competition could result in an average market performance that under-estimates the level of performance required to take share: that is, to compete with the dominant market leader. So, care must be taken when computing market averages, particularly when competitor share within the market is not homogeneously distributed. In most cases, it is likely that revenue-weighted averages should work well.

Returning to FIG. 2, strategic process assessment engine 108 includes models with associated parameters whose values provide measurements of the strength/quality of an entity's strategic processes for creating customer and business value. The indices are tracked over time by another tool—such as strategy capture and tracking tool 104, or tool 104 in combination with another forecasting tool (not shown)—to provide entities with a trend of their strategic planning progress, and to provide opportunities to improve the current strategy.

The value-creation engines defined in FIG. 2 are arranged as 12-slices in a pie radar chart. Each slice of the pie is quantitatively represented by: (1) Customer Value Creation [CVC] metrics of Effectiveness (denoted by α) and (2) Business Value Creation [BVC] metrics of Efficiency (denoted by β). The α-metrics are related to client organization growth potential, whereas the β-metrics are more closely related to client organization margin potential.

The maximum values of the CVC metrics is 1. The industry average value of the BVC metrics is normalized to 0.5 to facilitate graphing on the radar chart. Initially, the Engine scores can be manually calculated using a rules-based approach. Longer term, these scores can be obtained using a Machine Learning approach.

The metrics for the twelve engines can be looked at singly or combined into higher-level measures. The simplest combinations are to combine metrics in each of four quadrants. There are four such quadrant groupings or Actions-Providing (upper left), Satisfying (lower left), Opportunity (upper right), and Supporting (lower right).

Entities execute Jobs, measured by outcomes, to create and exchange value as they seek to achieve their respective goals. Each achieves their goal (“The What) through a set of jobs which can be described as a set of processes (“The How”). A customer desires his job accomplished or his needs met. The processes are a combination of creation and transfer of value. A venture wishes to help a customer accomplish their job. These processes are a combination of consumption and transfer of value (resources). Efficiency depends heavily on the state of the company compared to competitors. Because it is an efficiency measure, implying partial differential equations, the current state influences the efficiency.

This defines two related sets of processes for a customer and a venture to achieve their goals. These are called the customer value creation process and the business value creation process. These two sets of processes are both necessary and sequential (both the customer and the venture must complete all the processes to achieve their goal). These sequential processes are set of mutually exclusive set of states that a customer and a venture are moving through. Each state represents a creation or transfer step. This mutual exclusivity of the sequence of states makes this a basis set. Each creation or transfer process can be represented by one primary metric (which must be a process quality metric)

Each creation or transfer process can be further broken down into a sub-set of processes, but each of these sub-processes must be mutually exclusive and may be necessary, but not sufficient to achieve the state transition if there is more than one sub-process.

There may be a degenerate set of sub-processes that accomplish the state transition, but they represent different ways to move through the state, not different states.

There are four Action Quality Indices representing each of the four quadrants. The Action Quality Indicators have the following generalized form:

$${AQI}_{i} = \frac{1}{3} {{\sum }_{j = 1}}^{3} {EQI}_{j , α}$$

Where AQI_{i,α} is the quality indicator for the i^{th} quadrant. These Action algorithms generate four Action Quality Indices. The generalized list of Actions is AQI; where i ranges from 1 to 4. The following algorithm parameter names are used:

$$AQI 1 = ProA ( PROVIDING Action )$$

$$AQI 2 = SatA ( SATISFYING Action )$$

$$AQI 3 = OppA ( GENERATING Action )$$

$$AQI 4 = SupA ( SUPPORTING Action )$$

### Dynamic Quality Indicators.

The metrics of the twelve Value-Creation Engines can be combined to create new measures (Actions) that can provide unique lenses through which to view and assess the client organization. For example, combining the three metrics that span the blue-colored quadrant, gives a measure of the client organization's strength in Providing offerings to their customers. Continuing this amalgamation scheme allows us to create additional metrics. Action metrics can be combined—two at a time—to create higher-level metrics that we call “Dynamics.” There are 6 such Action-pairing possibilities, each providing a new and unique Dynamics assessment metric. The Dynamics Assessment metrics are:

$$DQI 2 = BvcF ( Bus - Value Creation Dyn )$$

$$DQI 3 = ExtF ( External Dynamic )$$

$$DQI 4 = IntF ( Internal Dynamic )$$

$$DQI 5 = PrbF ( Prod Balance Dynamic )$$

$$DQI 6 = MabF ( Mkt Balance Dynamic )$$

As with prior metrics, each of these 6 metrics is composed of two measures: one for effectiveness (α), and one for efficiency (β).

The Dynamics Quality Indicators (DQI) Algorithms have the following generalized form

$${DQI}_{i} = \frac{1}{6} {{\sum }_{j = 1}}^{6} {EQI}_{j}$$

where DQI_{i,α} is the quality indicator for the i^{th} Dynamic.

Developing, assessing, and tracking an organization's strategy and strategic quality requires creating a set of models that describe and predict the outcomes of an organization's strategic processes. These models are expected to be a combination of both rule-based approaches, where existing knowledge allows us to explicitly document and define a process, and empirical approaches, that can be developed, for example, using machine learning. The modeled processes can then be scored, and these scores compared to peer competitors to determine a Strategic Processes Quality Index (SPQI)—a measure of the overall strength of the combined processes that constitute a strategic plan. Many additional indices—that provide scores at a more granular level—can also be calculated, as will become apparent later in this document.

To facilitate creating and improving these process models over time, analysis may begin with a process hierarchy that utilizes both abstraction layers (so models can be created and refined in a hierarchical sense), and componentization (which allows different parts of the model to be updated without requiring changes and validation of other parts of the model).

The Strategic Processes Quality Index (SPQI) is the highest-level measure of strategic plan strength. The Strategic Processes Quality Index (SPQI) Algorithm for total value-creation are easily calculated from any of the lower-level metrics as shown below.

$$SPQI = \frac{1}{12} {{\sum }_{j = 1}}^{12} {EQI}_{j}$$

Where SPQI is the sum of all the engine quality indicators. The base values-those of the Engines-provide all of the values for the hierarchy of higher-level metrics just described.

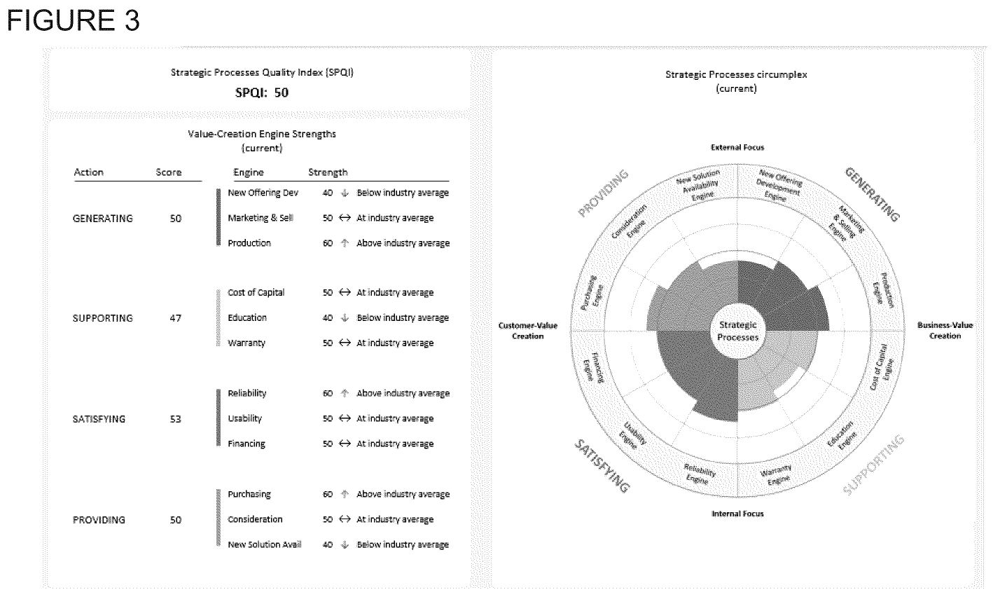

FIG. 3 illustrates example results from strategic process assessment engine 108 to determine a Strategic Processes Quality Index (SPQI). In this example, the new offering engine generates a strength of 40, the marketing and sell engine generates a strength of 50, and the production engine generates a strength of 60 for a generating action score of 50. The cost of capital engine generates a strength of 50, the education engine generates a strength of 40 and the warranty engine generates a strength of 50 for a supporting score of 47. The reliability engine generates a strength of 60, the usability engine generates a strength of 50, and the financing engine generates a strength of 50 for a score of 53. The purchasing engine generates a strength of 60, the consideration engine generates a strength of 50, and the new solution available engine generates a strength of 40 for a score of 50. With these data inputs, the strategic processes quality index (SPQI) is 50.

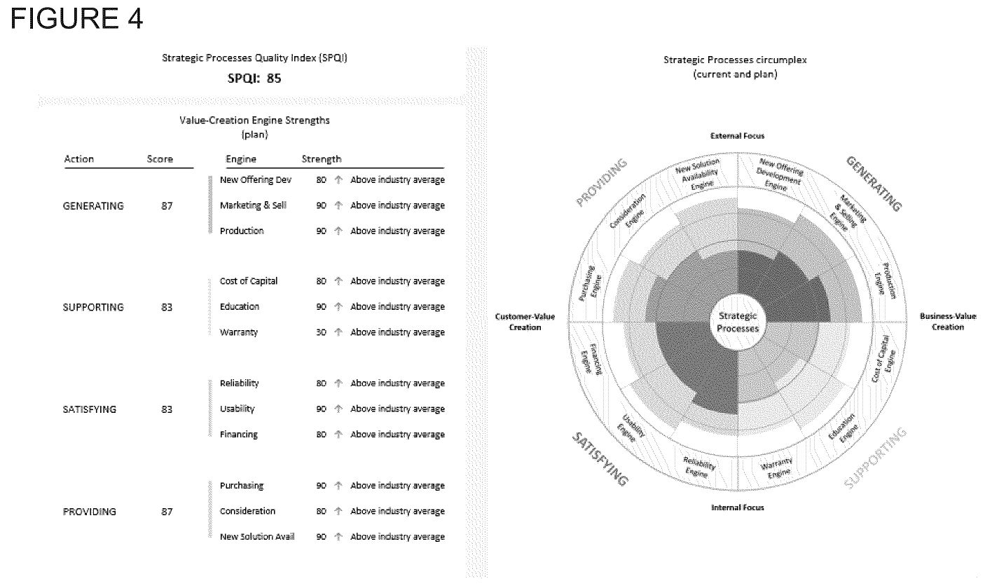

FIG. 4 illustrates example results from strategic process assessment engine 108 overlaid onto goals or planned results. In this example, the goal of the new offering engine was a strength of 80, the goal of the marketing and sell engine was a strength of 90, and the goal of the production engine was a strength of 90 for a generating action score goal of 87. The goal of the cost of capital engine was a strength of 80, the goal of the education engine was a strength of 90, and the goal of the warranty engine was a strength of 30 for a supporting score goal of 83. The goal of the reliability engine was a strength of 80, the goal of the usability engine was a strength of 90, and the goal of the financing engine was a strength of 80 for a satisfying score goal of 83. The goal of the purchasing engine was a strength of 90, the goal of the consideration engine was a strength of 80, and the goal of the new solution available engine was a strength of 90 for a providing score goal of 87. With these goal inputs, the strategic processes quality index (SPQI) goal was 85.

Several of the Engine Quality Indicators are calculated as an average of the client's performance to the industry average performance. In these cases, the generalized form of the equation we use to calculate the score can be written as

$${EQI}_{x} = OSC ( Metric , BOS ) = 1 + {[ \frac{Client}{Industry} ]}^{BOS}$$

Client is the client organization's nominal performance for a specific metric. For example, the client's Mean Time to Repair (MTTR) metric could be 5 days. Industry is the industry's average performance for the same metric. For example, the medical equipment industry may have an expected Mean Time to Repair (MTTR) of 2 days.

BOS, which is an acronym for Business Outcome Sensitivity is a power greater than zero that can range from approximately ⅕ to 5 that represents the sensitivity a venture outcome has to a change in a specific EQI metric. The EQIx equation written above will be labelled OSC (Metric, BOS) for Outcome Sensitivity Calculator. Throughout this document we substituted OSC (Metric, BOS) while writing the EQI equations. The default value for BOS is +1.

FIG. 5 illustrates results from culture assessment engine 110. In this example, the strategic direction engine generates a strength of 40, the goals and objectives engine generates a strength of 60, and the vision engine generates a strength of 70 for a mission trait score of 57. The coordination engine generates a strength of 95, the agreement engine generates a strength of 80, and the core values engine generates a strength of 90 for a consistency trait score of 88. The empowerment engine generates a strength of 60, the team organization engine generates a strength of 70, and the capability engine generates a strength of 60 for an involvement trait score of 63. The organizational learning engine generates a strength of 70, the customer focus engine generates a strength of 80, and the create change engine generates a strength of 70 for an adaptability trait score of 73. With these data inputs, the culture quality index (CQI) is 42.

Subsequently, results from engines 108, 110 may be correlated by alignment assessment tool 112. Areas of overlap may be analyzed and produced. Overlaps of results may form an area point of view, and the degree of overlap may be used to evaluate the fit of personal and company data. The analysis may run many times to find the best overlap, which may be reverse-analyzed to identify metrics that should be used for improvement. Alignment assessment tool 112 may determine whether a company culture aligns with and fully supports a given strategy. Alignment assessment tool 112 may also determine which cultural traits, if strengthened, will have the greatest impact on strategy success.

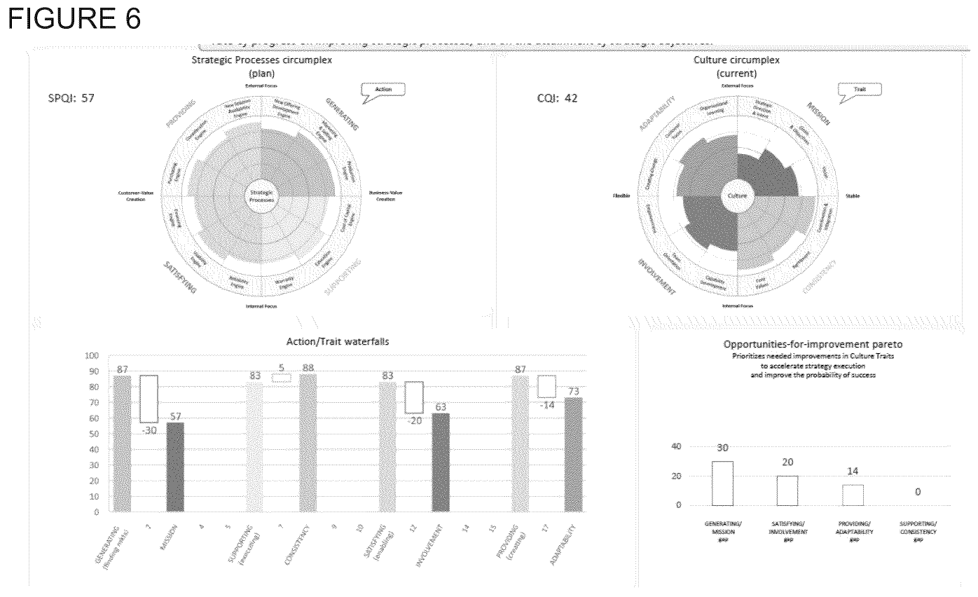

FIG. 6 illustrates results from alignment assessment tool 112 based on the action outputs of strategic process assessment engine 108 and trait outputs of the culture assessment engine 110. The action/trait waterfalls indicate which culture traits are to be prioritized to accelerate strategy execution and improve the probability of success. In particular, the generating/mission gap is 30, so the mission culture traits should be prioritized.

Alignment assessment tool 112 may be configured to correlate the results from engines 108, 110 and estimate the probabilities of decision outcomes to be made by forecast tool 114. Forecast tool 114 may determine how accurate is a financial forecast over a strategic horizon, accounting for external and internal risks. Forecast tool 114 may also determine how confidence in achieving strategic objectives may be increased.

Returning to FIG. 2, forecast tool 114 may be configured to perform forecasting based upon outputs of tools 110, 112.

Any strategic plan, and specifically the financial forecasts associated with it, represent the best estimate of the outcomes associated with implementing an organization's strategic and cultural processes. Forecast tool 114 includes a set of algorithms, such as open source Monte Carlo Estimation algorithms for estimating the expected outcome of a set of assumptions and plans.

Forecast tool 114 estimates the 3-5 year Profit and Loss (Income) statement for an organization. The Income statement estimation is based on the values of the strategic process and culture engines at the appropriate time in the future. Each of the Strategic Process Quality Index (SPQI) and Culture Quality Index (CQI) scores are used to compute either the Revenue, COGS, or OpEx components of the Income Statement.

Thus, forecast tool 114 ingests the assumptions for the SPQIs and the CQI over time, which implicitly contain forecasts for how competitors and markets will evolve over time. It then uses a set of Monte Carlo Estimation routines to estimate each of the components of an income statement and populates the income statement with mean values. Using selected ranges, it can also create upside and downside scenarios for comparison.

Forecast tool 114 may assume a normal distribution function for all assumption variables, but may be able to use AI and big data tools to estimate and update the assumptions.

The efficacy of forecast tool 114 may be dependent upon the appropriate capture and input of the assumptions that are used to describe each of the Strategic Process Assessment Engine (SPE) components.

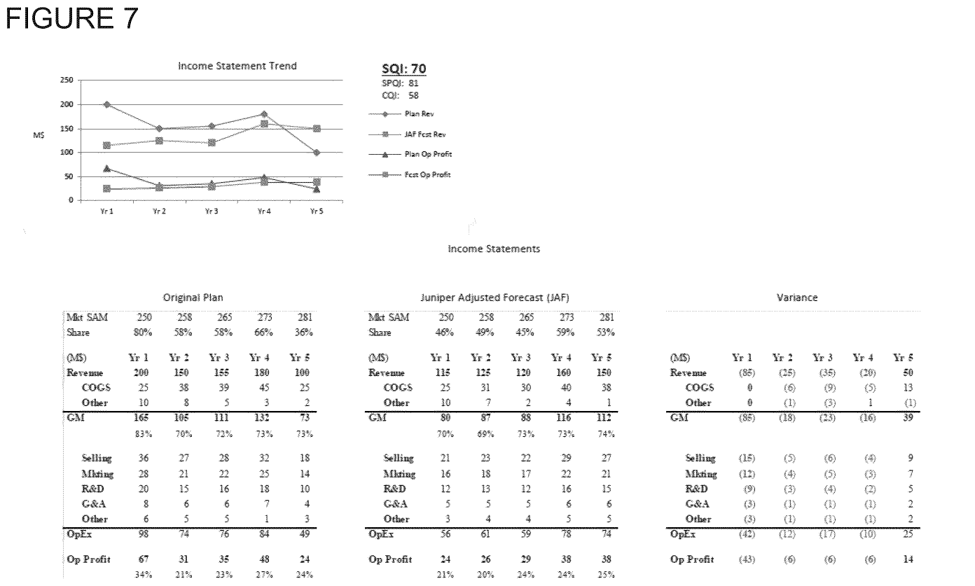

FIG. 7 illustrates results from forecast tool 114 based on the outputs of alignment assessment tool 112. In this example, the SPQI is 81 and the CQI is 58. An income statement trend chart is generated for years 1 to 5, including: a plan rev, an adjusted forecast, a plan operating profit, and a forecast operating profit. Key takeaways from the income statement trend chart include: (1) the forecasted revenue below the plan in years 2, 3, 4, and 5; forecasted operating profit below the plan in years 2, 3, 4, and 5; a recommendation to improve CQI by addressing top pareto opportunities; and a recommendation to strengthen SPQI y focusing on Supporting Actions, particularly by investing in the manufacturing customer value-creation engine to meet or exceed industry averages. The forecast tool 114 may generate income statements based on the outputs of alignment assessment tool 112.

The forecast tool 114 may implement a four-step process for estimating a forecast. First, the question may be broken down into independent parts. Second, estimate a base rate for each of the independent parts. Third, identify first order corrections for the independent parts. Fourth, combine the values, wherein you initially start with an average and then extremize.

Forecasting engine: Strategy and Culture Quality Indices

For each of the SPQIs and the Culture Quality Index (CQI), we will use a consistent approach. The user will capture the assumptions that are used to estimate a specific Engine Quality Index (EQIx) at the current point in time. In the case where a component of the EQIx calculation requires an industry average, the algorithm will capture the inherent assumptions that were used to develop the industry average.

For each of the Strategic Process Assessment Engines and the Culture Quality Assessment Engines (collectively, SPEs) or value creating engines, there is the option of an abstracted assumption set (A) or a component assumption set (C). For each option, A or C, there is an additional option for adding a causal assumption (h for hypothesis) or an outcome assumption (o) set. The causal assumption is documenting the hypothesis of why a specific engine or engine component will change over time. These hypothesis-based engine assumptions can then be validated continuously. The outcome assumption set is simply a speculative estimate of the rates and changes without the underlying hypothesis and thus can be validated in terms of outcome accuracy, but not the underlying root cause of any gap.

For any engine, initially only an abstracted or component assumption set may be used. The use of both simultaneously requires an estimation and correction for the overlap in the assumption impact, which will be a roadmap option.

Thus, for each engine there are 4 potential representations:
Ah: Top level assumption set with hypothesis captured.
Ao: Top level assumption set with outcome predictions only.
Ch: Component level assumption set with hypothesis capture for each component. This is the most detailed and exhaustive representation and consumes significant data.
Co: Component level assumption set with outcome predictions only. This is the second most detailed set.

There is another distinction that it is important to capture for the purposes of execution tracking and external market environment changes. Assumptions can be broadly classified as external, meaning they have to do the market environment, competitors, customers or things that are largely considered outside the control of the venture. Then there are internal assumptions, that product development will release a product in a specific quarter, that sales will generate a number of new customer leads in a period. These are very different assumptions with regards to their tracking and validation. Our input and tracking tools will differentiate these as this distinction becomes important when identifying the root cause and potential corrective measures when a venture fails to achieve its objectives. This will be accomplished by annotating an assumption as Xe for external or Xi for internal; for example, Ahi is a top-level hypothesis assumption about an internal capability or initiative.

Showing this in detail in the following example for the New Solution Availability (NSA) Engine. For example, the NSA equation is written as:

$$NSA = \frac{1}{M} {{\sum }_{m = 1}}^{M} [ \frac{{MarketSolutionScore}_{m}}{{MarketODIScore}_{m}} ]$$

The NSA equation can then be represented by one of two assumption table sets:

| | | | | Change | |
|---|---|---|---|---|---|
| | | | | to Base | |
| | | | Base | Rate | |
| | | Base | Rate | Per | Change |
| Assumption (Abstracted) | Type | Rate | Range | Year | range |
| Overall Market Solution | Ahi | 60% | +/−5% | 10% | +/−1% |
| Score will be 60% of the | | | | | |
| Market Needs and will | | | | | |
| increase to 80% in 2 years | | | | | |
| Competitor solution is 60% | Ahc | 60% | +/−5% | 0 | +/−0.5% |
| and they do not have a | | | | | |
| roadmap in this space | | | | | |

| | | | | Change | |
|---|---|---|---|---|---|
| | | | | to Base | |
| | | | Base | Rate | |
| | | Base | Rate | Per | Change |
| Assumption (Component) | Type | Rate | Range | Year | range |
| Overall Market Solution | Chi | 60% | +/−5% | 5% | +/−1% |
| Score will be 60% of the | | | | 15% | |
| Market Needs and will | | | | | |
| increase to 80% in 2 years | | | | | |
| based on Two R&D | | | | | |
| programs completing on | | | | | |
| schedule and delivering | | | | | |
| 5% and 15% of the | | | | | |
| increased benefit | | | | | |
| Competitor organizational | Che | 6% | +/−5% | 0 | +/−0.5% |
| awareness will remain flat | | | | | |
| as they are not investing | | | | | |
| in brand | | | | | |

With these assumptions of the Strategic Process Assessment Engines and the Culture Quality Assessment Engines (collectively, SPEs) or value creating engines, a Monte Carlo Estimation technique may be used to create a forecast value for an SPE (t), which is the value over time. Consistent with Tetlock's principles, these will be extremized after calculation and we will use as many assumptions as can be estimated as there is no cognitive load to include them. For each assumption, the updating algorithm may optionally be used to automatically update the EQIx score when a new fact is discovered and then recalculate the forecast. Forecasts are typically less than five years.

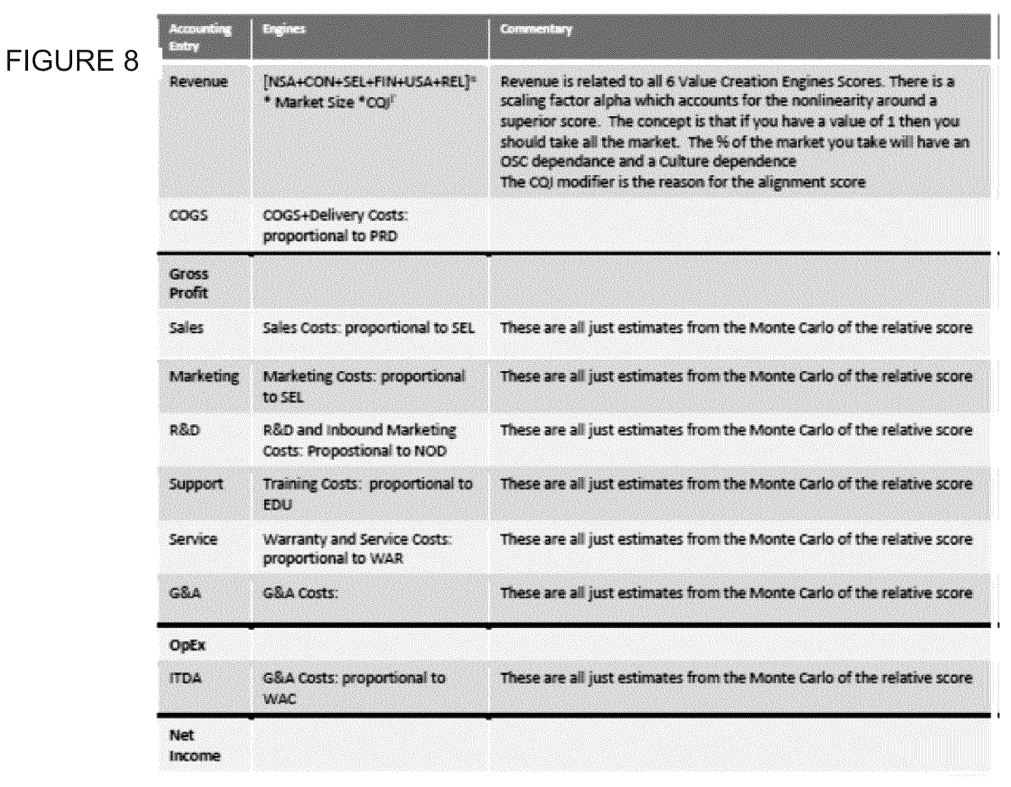

Then with the SPEx(t) calculations for the following engines, revenue for any period is calculated as shown in FIG. 8.

FIG. 8 illustrates a table, showing the relationships of the specific SPEx and the CQI and how they are used to estimate a multi-year Income Statement. For all the engine and index scores below, the time series SPEx(t) are computed as shown in FIG. 8. An existing client Operating/Financial model can be used to assess whether a strategy can be successful given certain investment constraints. The NSA Score may b increased while the R&D investment is reduced as a percentage of revenue. However, this requires computing the income statement and the relationship with the SPQI and CQI scores in a different manner. A constraint calculation approach may be added that limits the range of the SPE and CQI to the financial forecast and show both the estimation with current forecast constraints on spending and the desired. This may be relevant for scenario comparisons.

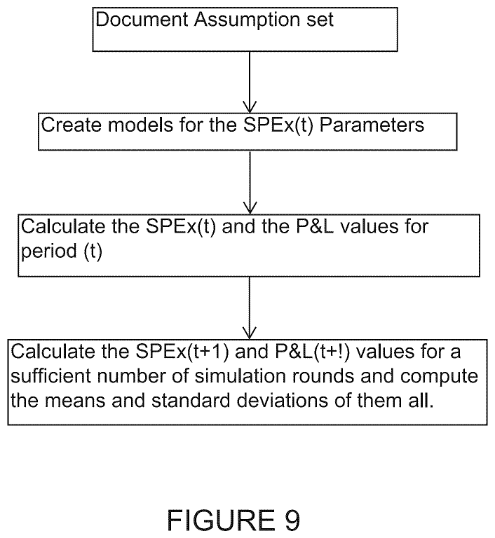

FIG. 9 illustrates a process for calculation of the SPEx(t) and income statement. For convergence and tractability, the initial algorithm will calculate SPEx(t) for a specific period using the initial values from the SPEx(t) calculation from the previous period. This can be expanded to a multi-period optimization if necessary, as a road map item. The financial values for the period will be simultaneously estimated and updated period by period.

For each of the Strategy Process Engines, the values are computed for a period t of SPEx(t) using the captured assumption table as inputs to a Monte Carlo Estimation technique and the mean and ranges are reported for use in calculation a range of variables. If components are used and the components have multiple sub-functions, a Monte Carlo Estimation of the sub-components is used first.

There is a master MC function which takes in as input, an engine or sub-component of interest, the assumption table (with the list of descriptors, abstract vs component, and then internal vs external) and computes the values for a specific instance. This is then created for each of the sub-components and then each of the SPEx(t) and each of the industry constants in the financial table.

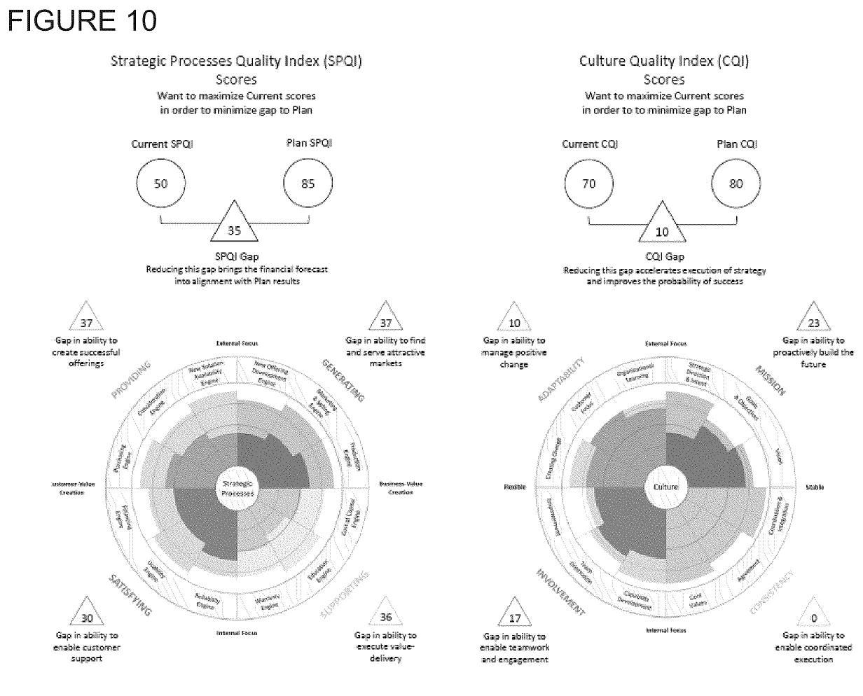

FIG. 10 illustrates additional results from forecast tool 114 based on the outputs of alignment assessment tool 112. By watching just a handful of gap values (the ten numbers inside the delta, or triangle, shapes) progress of strategic processes and culture may be tracked. The goal may be to make improvements to drive these gap values to zero. A gap of zero means that an entity made the necessary improvements to successfully execute their strategy. In this example, only the “Consistency” gap has been reduced to zero. All of the other gaps require reduction to avoid falling short of goals. By closing these gaps—between current and planned values in both strategic processes and culture—a strategy may be validated.

Primary gaps may be created by complexity. A strategic process gap SP(xᵢ) may be created where there is a limitation in strategy and strategy processes. Strategy processes comprise a set of dependent variables (xᵢ). Algorithms measure causality of gaps in process effectiveness for a given set of input (xₒ). All processes are assumed deterministic. An operating model gap AA (dᵢ) may be created where there is a deviation of employee actions from expectations. Algorithms measure causality of set of actions an organization's individuals will take based on their specific decisions. This is a measure of culture and decision making effectiveness. The strategic process gap SP(xᵢ) and the operating model gap AA (dᵢ) may be multiplied by a risk gap outcome O(P(t)) to obtain the actual results achieved. The risk gap outcome O(P(t)) may equal an actual outcome given a set of deterministic and non-deterministic events. The stochastic process affect both the strategic plans and the organization's actions. The primary gaps may be modeled with hybrid models, which may incorporate machine learning to improve with customer usage.

Entities combine various inputs (labor, capital), in a holistic set of processes to create and deliver value to their targeted customers in exchange for money. An organization's strategy describes how this combination of processes, denoted SP(xi), will be utilized to achieve an organization's goals.

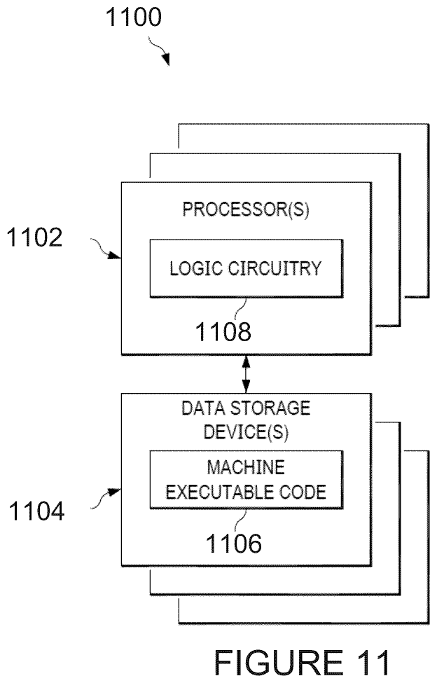

FIG. 11 is a block diagram of circuitry 1100 that, in some aspects, may be used to implement various functions, operations, acts, processes, and/or methods disclosed herein. The circuitry 1100 includes one or more processors 1102 (sometimes referred to herein as “processors 1102”) operably coupled to one or more data storage devices (sometimes referred to herein as “storage 1104”). The storage 1104 includes machine executable code 1106 stored thereon and the processors 1102 include logic circuitry 1108. The machine executable code 1106 includes information describing functional elements that may be implemented by (e.g., performed by) the logic circuitry 1108. The logic circuitry 1108 is adapted to implement (e.g., perform) the functional elements described by the machine executable code 1106. The circuitry 1100, when executing the functional elements described by the machine executable code 1106, may be considered as specific purpose hardware configured for carrying out functional elements disclosed herein. In some aspects the processors 1102 may perform the functional elements described by the machine executable code 1106 sequentially, concurrently (e.g., on one or more different hardware platforms), or in one or more parallel process streams.

When implemented by logic circuitry 1108 of the processors 1102, the machine executable code 1106 adapts the processors 1102 to perform operations of aspects disclosed herein. For example, the machine executable code 1106 may adapt the processors 1102 to perform at least a portion or a totality of the inference methods of FIGS. 1B and 9. As another example, the machine executable code 1106 may adapt the processors 1102 to perform at least a portion or a totality of the operations discussed for the circuits of FIG. 1A. As a specific, non-limiting example, the machine executable code 1106 may adapt the processors 1102 to perform at least a portion of the inference operations discussed herein.

The processors 1102 may include a general purpose processor, a specific purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a specific-purpose computer while the general-purpose computer is operable to execute functional elements corresponding to the machine executable code 1106 (e.g., software code, firmware code, hardware descriptions) related to aspects of the present disclosure. It is noted that a general-purpose processor (may also be referred to herein as a host processor or simply a host) may be a microprocessor, but in the alternative, the processors 1102 may include any conventional processor, controller, microcontroller, or state machine. The processors 1102 may also be implemented as a combination of computing devices, such as a combination of a DSP and a microprocessor, a plurality of microprocessors, one or more microprocessors in conjunction with a DSP core, or any other such configuration.

In some aspects the storage 1104 includes volatile data storage (e.g., random-access memory (RAM)), non-volatile data storage (e.g., Flash memory, a hard disc drive, a solid state drive, erasable programmable read-only memory (EPROM), without limitation). In some aspects the processors 1102 and the storage 1104 may be implemented into a single device (e.g., a semiconductor device product, a system on chip (SOC), without limitation). In some aspects the processors 1102 and the storage 1104 may be implemented into separate devices.

In some aspects the machine executable code 1106 may include computer-readable instructions (e.g., software code, firmware code), By way of non-limiting example, the computer-readable instructions may be stored by the storage 1104, accessed directly by the processors 1102, and executed by the processors 1102 using at least the logic circuitry 1108. Also by way of non-limiting example, the computer-readable instructions may be stored on the storage 1104, transferred to a memory device (not shown) for execution, and executed by the processors 1102 using at least the logic circuitry 1108. Accordingly, in some aspects the logic circuitry 1108 includes electrically configurable logic circuitry 1108.

In some aspects the machine executable code 1106 may describe hardware (e.g., circuitry) to be implemented in the logic circuitry 1108 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, System Verilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1108 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some aspects, the machine executable code 1106 may include an HDL, an RTL, a GL description, a mask level description, other hardware description, or any combination thereof.

In aspects where the machine executable code 1106 includes a hardware description (at any level of abstraction), a system (not shown, but including the storage 1104) may be operable to implement the hardware description described by the machine executable code 1106. By way of non-limiting example, the processors 1102 may include a programmable logic device (e.g., an FPGA or a PLC) and the logic circuitry 1108 may be electrically controlled to implement circuitry corresponding to the hardware description into the logic circuitry 1108. Also, by way of non-limiting example, the logic circuitry 1108 may include hard-wired logic manufactured by a manufacturing system (not shown, but including the storage 1104) according to the hardware description of the machine executable code 1106.

Regardless of whether the machine executable code 1106 includes computer-readable instructions or a hardware description, the logic circuitry 1108 is adapted to perform the functional elements described by the machine executable code 1106 when implementing the functional elements of the machine executable code 1106. It is noted that although a hardware description may not directly describe functional elements, a hardware description indirectly describes functional elements that the hardware elements described by the hardware description are capable of performing.

Although examples have been described above, other variations and examples may be made from this disclosure without departing from the spirit and scope of these disclosed examples.

What is claimed is:

1. An article of manufacture comprising:
an assessment tool circuit associated with a processor;
a plurality of value creating engine circuits associated with the processor;
an alignment assessment tool circuit associated with the processor;
a forecast tool circuit associated with the processor; and
a non-transitory machine-readable medium, the medium including instructions, the instructions, when loaded and executed by the processor, cause the processor to:
gather data relating to a plurality of value characteristics regarding a venture and a market from one or more data sources regarding the venture and the market;
generate a plan circumplex, via the assessment tool circuit, visually representing plan strength scores of the plurality of value characteristics, respectively, and calculate a plan index of the plan circumplex;
generate an actual circumplex, via the plurality of value creating engine circuits, visually representing actual strength scores of the value characteristics and calculate an actual index of the actual circumplex;
align the actual circumplex with the plan circumplex, via an alignment assessment tool circuit, to identify value characteristics having large disparity between plan strength scores and actual strength scores; and
forecast financial performance of the venture, via a forecast tool circuit, based on the plan strength scores, the actual strength scores, the plan index, and the actual index.

2. The article of manufacture as in claim 1, wherein the assessment tool circuit is a strategic processes assessment tool circuit, and wherein the plan index and the actual index comprise a plan Strategic Process Quality Index (SPQI) and an actual Strategic Process Quality Index (SPQI), respectively.

3. The article of manufacture as in claim 1, wherein the assessment tool circuit is a culture assessment tool circuit, and wherein the plan index and the actual index comprise a plan Culture Quality Index (CQI) and an actual Culture Quality Index (CQI), respectively.

4. The article of manufacture as in claim 1, wherein the plurality of value characteristics comprise at least twelve value characteristics and the plurality of value creating engines comprise at least twelve value creating engines.

5. The article of manufacture as in claim 1, wherein the plurality of value characteristics comprise at least one of: purchasing, consideration, new solution, new offering development, marketing and selling, production, cost of capital, education, warranty, reliability, usability, and financing.

6. The article of manufacture as in claim 1, wherein the plurality of value characteristics comprise at least one of: strategic direction, goals and objectives, vision, coordination and integration, agreement, core values, capability development, team orientation, empowerment, creating change, customer focus, and organizational learning.

7. The article of manufacture as in claim 1, wherein calculate a plan index of the plan circumplex comprises averaging the plan strength scores, and wherein calculate an actual index of the actual circumplex comprises averaging the actual strength scores.

8. The article of manufacture as in claim 1, wherein forecast financial performance of the venture comprises computing a metric selected from revenue, COGS, or operating expense of an income statement based on an alignment of the actual circumplex with the plan circumplex.

9. The article of manufacture as in claim 1, wherein forecast financial performance of the venture comprises forecasting based on assumptions for the value creating engine circuits as a function of time.

10. A method comprising:
gathering data relating to a plurality of value characteristics regarding a venture and a market from one or more data sources regarding the venture and the market;
generating a plan circumplex, via the assessment tool circuit, visually representing plan strength scores of the plurality of value characteristics, respectively, and calculate a plan index of the plan circumplex;
generating an actual circumplex, via the plurality of value creating engine circuits, visually representing actual strength scores of the value characteristics and calculate an actual index of the actual circumplex;
aligning the actual circumplex with the plan circumplex, via an alignment assessment tool circuit, to identify value characteristics having large disparity between plan strength scores and actual strength scores; and
forecasting financial performance of the venture, via a forecast tool circuit, based on the plan strength scores, the actual strength scores, the plan index, and the actual index.

11. The method as in claim 10, wherein the assessment tool circuit is a strategic processes assessment tool circuit, and wherein the plan index and the actual index comprise a plan Strategic Process Quality Index (SPQI) and an actual Strategic Process Quality Index (SPQI), respectively.

12. The method as in claim 10, wherein the assessment tool circuit is a culture assessment tool circuit, and wherein the plan index and the actual index comprise a plan Culture Quality Index (CQI) and an actual Culture Quality Index (CQI), respectively.

13. The method as in claim 10, wherein the plurality of value characteristics comprise at least twelve value characteristics and the plurality of value creating engines comprise at least twelve value creating engines.

14. The method as in claim 10, wherein the plurality of value characteristics comprise at least one of: purchasing, consideration, new solution, new offering development, marketing and selling, production, cost of capital, education, warranty, reliability, usability, and financing.

15. The method as in claim 10, wherein the plurality of value characteristics comprise at least one of: strategic direction, goals and objectives, vision, coordination and integration, agreement, core values, capability development, team orientation, empowerment, creating change, customer focus, and organizational learning.

16. The method as in claim 10, wherein calculate a plan index of the plan circumplex comprises averaging the plan strength scores, and wherein calculate an actual index of the actual circumplex comprises averaging the actual strength scores.

17. The method as in claim 10, wherein forecast financial performance of the venture comprises computing a metric selected from revenue, COGS, or operating expense of an income statement based on an alignment of the actual circumplex with the plan circumplex.

18. The method as in claim 10, wherein forecast financial performance of the venture comprises forecasting based on assumptions for the value creating engine circuits as a function of time.
